(19) United States
(12) Patent Application Publication
(10) Pub. No.: US 2013/0043312 A1
(43) Pub. Date: Feb. 21, 2013

(54) CODE SYMBOL READING SYSTEM EMPLOYING DYNAMICALLY-ELONGATED LASER SCANNING BEAMS FOR IMPROVED LEVELS OF PERFORMANCE

(71) Applicant: Erik Van Horn, Ocean View, NJ (US)

(72) Inventor: Erik Van Horn, Ocean View, NJ (US)

(73) Assignee: Metrologic Instruments, Inc.

(21) Appl. No.: 13/209,605

(22) Filed: Aug. 15, 2011

(51) Int. Cl. G06K 7/10

(52) U.S. Cl. 235/462.1; 235/462.27; 235/462.32

(57) ABSTRACT

A laser scanning bar code symbol reading system for scanning and reading poor quality and damaged bar code symbols in flexible operating conditions. The system includes a housing having a light transmission window; a dynamically-elongated laser beam production module, including a multi-cavity visible laser diode (VLD), for producing a dynamically-elongated laser beam having (i) a direction of propagation extending along a z reference direction, (ii) a height dimension being indicated by the y reference direction, and (iii) a width dimension being indicated by the x reference direction, where x, y and z directions are orthogonal to each other. Each dynamically-elongated laser beam is characterized by an elongation ratio (ER) that is defined as Y/X where, for any point within the working range of the laser scanning bar code symbol reading system, extending along the z direction, (i) Y indicates the beam height of the dynamically-elongated laser beam measured in the Y reference direction, (ii) X indicates the beam width of the dynamically-elongated laser beam measured in the X reference direction, and (iii) the beam height (Y) and the laser beam width (X) are measured at 1/e² intensity clip level. A laser scanning mechanism is provided for scanning the dynamically-elongated laser beam out the light transmission window and across a scanning field defined external to the housing, in which a bar code symbol is present for scanning by the dynamically-elongated laser scanning beam.

### BACKGROUND OF DISCLOSURE

1. Field of Disclosure

The present disclosure relates to improvements in bar code symbol reading systems employing laser scanning beams having improved laser beam characteristics which enable the reading of poor quality and/or damaged bar code symbols with enhanced levels of performance.

2. Brief Description of the State of Knowledge in the Art

It is well known that poor quality bar codes and damaged bar codes typically results in decreased throughput at the retail point of sale (POS).

Various techniques have been developed to read poor quality bar codes and damaged bar codes. Such techniques include using: (i) adaptive signal processing gain adjustments and threshold levels (usually performed over a period of several sweeps across the bar code); (ii) reduced signal processing bandwidth to limit high frequency components of scanned data (i.e. limits scanner resolution); (iii) improved decode algorithms to allow for noise in bar code printing; and (iv) stitching algorithms to acquire a full decode out of partially successful attempts to acquire a whole bar code result.

In addition to the above techniques, it is well known to use of an elongated laser beam in the cross-sectional direction of laser beam scanning motion, so as to help average out spatial noise and improve the signal to noise (SNR) of the laser scanning bar code reading system. This technique can be used to read both 1D and 2D stacked bar code symbols.

For example, U.S. Pat. No. 5,621,203 discloses the use of an elongated laser beam for scanning 2D stacked bar code symbols and detecting reflected light using a linear image detector. As disclosed, the elongated laser beam which diverges in the elongated cross-sectional dimension. Also, the elongated cross-sectional dimension of the beam, in the plane of the symbol, is preferably long enough to illuminate the entirety of one dimension of a row of the symbol, at one time. The beam preferably does not converge to a waist in the elongated cross-sectional dimension.

FIG. 1 shows a bar code symbol reading system 1 scanning a conventionally-elongated laser beam 10 across a bar code symbol 116. FIG. 2A1 shows a good quality UPC bar code symbol being scanned by the conventionally elongated laser scanning beam 10 from the bar code symbol reading system of FIG. 1. The reflectance intensity profile produced while scanning this good quality code symbol with the conventionally elongated laser scanning beam 10 is shown in FIG. 2A2.

FIG. 2B1 shows a degraded UPC bar code symbol being scanned by a conventionally elongated laser scanning beam 10 generated from the laser scanning bar code symbol reading system of FIG. 1. FIG. 2B2 shows the reflectance profile produced from the degraded bar code symbol using the conventionally elongated laser scanning beam produced from bar code symbol reading system of FIG. 1.

FIG. 2C1 shows the second layer of a good quality stacked 2D bar code symbol being scanned by a conventionally elongated laser scanning beam 10 produced from the laser scanning bar code symbol reading system of FIG. 1. FIG. 2C2 shows the reflectance profile produced from stacked 2D bar code symbol using the conventionally-elongated laser scanning beam 10 produced from the bar code symbol reading system of FIG. 1.

Using conventionally-elongated laser beams to scan bar code symbol structures with 2D surface noise smoothes out (i.e. via spatial averaging) the reflection intensity profile of such code symbols which, in turn, increases the signal to noise (SNR) performance of the bar code symbol reading system.

The elongation ratio (ER) of a laser beam, defined as the ratio of laser beam height (y) over laser beam width (x) measured along the direction of beam travel (Z) of the laser scanning beam, provides a measure of how much the laser beam is elongated along the cross (i.e. y) scan dimension of the beam, relative to the scan dimension (i.e. x direction). For known conventional laser scanning systems, the laser beam elongation ratio (ER) measures in the range of 1 to about 4.0, across the working range of conventional laser scanning bar code symbol reading systems, as illustrated in FIG. 2D.

However, hitherto, little has been known or disclosed about how to optimize the beam elongation ratio (ER) for a laser scanning bar code symbol reading system, so as to achieve enhanced levels of SNR performance when reading poor quality or damaged bar code symbols of various kinds of symbologies (e.g. UPC, GS1 2D stacked bar codes, etc).

Thus, there is a great need for improvement in the SNR of reflection intensity signals detected during laser scanning bar code symbols, and for this improvement to be achieving using laser scanning beams having optimized laser beam characteristics, while avoiding the shortcomings and drawbacks of prior art apparatus and methodologies.

### SUMMARY AND OBJECTS OF THE PRESENT DISCLOSURE

Accordingly, it is a primary object of the present disclosure is to provide a new and improved way of and means for improving the SNR of reflection intensity signals detected during laser scanning bar code symbols, and to do so using laser scanning beams having dynamically-optimized laser beam characteristics, while avoiding the shortcomings and drawbacks of prior art apparatus and methodologies.

Another object is to provide a new and improved method of reading poor quality and damaged barcodes by scanning such bar code symbols using a laser scanning beam having dynamically changing beam dimension characteristics in the non-scanning (Y) direction, so as to average out defects in the bar code symbol during laser scanning operations.

Another object is to provide a new and improved method of reading poor quality and damaged barcodes by scanning such bar code symbols using a laser scanning beam produced by a hand-supportable laser scanning bar code symbol reading system employing an electro-optical module that generates a laser scanning beam having dynamically changing laser beam elongation states that are electronically activated and driven during each laser scanning bar code symbol reading cycle, initiated by a triggering event in the system.

Another object is to provide a new and improved hand-supportable laser scanning bar code symbol reading system, wherein the electro-optical module employs a multi-cavity visible laser diode (VLD) having multiple laser cavities that are sequentially activated and driven during each laser scanning bar code symbol reading cycle, so as to produce a laser beam having dynamically-changing beam elongation characteristics along the y axis (i.e. non-scanning) direction, thereby allowing poor quality and degraded bar code symbols to be read by averaging out defects in the code symbols, while not be restricted by beam-code tilt requirements during scanning operations.

Another object is to provide a new and improved hand-supportable laser scanning bar code symbol reading system employing a multi-cavity visible laser diode (VLD) having multiple laser cavities, that are sequentially activated and driven during each laser scanning bar code symbol reading cycle, so as to produce a laser beam having dynamically-changing beam elongation characteristics along the y axis (i.e. non-scanning) direction, where the elongation of the laser scanning beam dynamically varies from a short elongation length allowing for increased tilt performance, to extreme elongation length allowing for poor quality code symbol to be read by averaging out defects in the code symbols.

Another object is to provide a new and improved hand-supportable laser scanning bar code symbol reading system, wherein the electro-optical module employs an adaptive variable-focus cylindrical lens element that is sequentially switched during each laser scanning bar code symbol reading cycle, so that the electro-optical module produces a laser beam having dynamically-changing beam elongation characteristics along the y axis (i.e. non-scanning) direction, thereby allowing poor quality and degraded bar code symbols to be read by averaging out defects in the code symbols, while not be restricted by beam-code tilt requirements during scanning operations.

Another object is to provide a new and improved hand-supportable laser scanning bar code symbol reading system, wherein the electro-optical module an adaptive variable-focus cylindrical lens element that is sequentially switched during each laser scanning bar code symbol reading cycle, so that the electro-optical module produces a laser beam having dynamically-changing beam elongation characteristics along the y axis (i.e. non-scanning) direction, where the elongation of the laser scanning beam dynamically varies from a short elongation length allowing for increased tilt performance, to extreme elongation length allowing for poor quality code symbol to be read by averaging out defects in the code symbols.

Another object is to provide a new and improved hand-supportable laser scanning bar code symbol reading system, wherein the electro-optical module employs an adaptive variable-focus cylindrical lens element, realized using either deformable or liquid crystal cylindrical lens element, that is sequentially reconfigured during each laser scanning bar code symbol reading cycle, so that the electro-optical module produces a laser beam having dynamically-changing beam elongation characteristics along the y axis (i.e. non-scanning) direction, thereby allowing poor quality and degraded bar code symbols to be read by averaging out defects in the code symbols, while not be restricted by beam-code tilt requirements during scanning operations.

Another object is to provide a new and improved hand-supportable laser scanning bar code symbol reading system, wherein the electro-optical module employs an adaptive variable-focus cylindrical lens element, realized using either deformable or liquid crystal cylindrical lens element, that is sequentially reconfigured during each laser scanning bar code symbol reading cycle, so that the electro-optical module produces a laser beam having dynamically-changing beam elongation characteristics along the y axis (i.e. non-scanning) direction, where the elongation of the laser scanning beam dynamically varies from a short elongation length allowing for increased tilt performance, to extreme elongation length allowing for poor quality code symbol to be read by averaging out defects in the code symbols.

Another object is to provide a laser scanning bar code symbol reading system employing a dynamically-elongated laser beam having an elongation ratio (ER) that can is quantified as: Y/X where; (i) for any point within the working range of the laser scanning bar code scanner (i.e. along the z direction of the scanner); (ii) Y indicates the laser beam height measured in the cross-scan direction or Y dimension laser beam, and X indicates the laser beam width measured in the scan direction or X dimension of the laser beam; and (iii) the laser beam height (Y) and laser beam diameter (X) are measured at 1/e² intensity clip level.

Another object is to provide a laser scanning bar code symbol reading system employing a curved mirror for creating laser beam elongation having a dynamically-varying elongation ratio (ER) along the length of beam propagation within the working range of the system, so as to improve the SNR performance of the system.

Another object is to provide a laser scanning bar code symbol reading system employing a cylindrical lens for creating laser beam having a dynamically-varying elongation ratio (ER) along the length of beam propagation within the working range of the system, so as to improve the SNR performance of the system.

Another object is to provide a laser scanning bar code symbol reading system employing an extremely elongated laser beam that can also be used in a bi-optic laser scanning systems, omni-directional laser scanning systems, and laser-illuminated linear imaging systems.

Another object is to provide a laser scanning bar code symbol reading system employing an extremely elongated laser beam that has been designed to balance GS1 composite stacked code performance with poor quality code performance.

Another object is to provide a laser scanning bar code symbol reading system employing a laser scanning beam whose elongation ratio is dynamically-varied from one extreme to another during each laser scanning cycle, so that the dynamically-elongated laser beam can read poor quality bar code symbols over the working range of the reader, as well as at the point of highest resolution (i.e. beam waist).

Another object is to provide a laser scanning bar code symbol reading system employing a dynamically-elongated laser beam having extreme elongation occurring at the waist of the beam profile at a value of 2.36 inches (i.e. 60 mm) from the light transmission window of the system.

These and other objects will become more apparent hereinafter and in the Claims appended hereto.

### BRIEF DESCRIPTION OF THE DRAWINGS

In order to more fully understand the Objects, the following Detailed Description of the Illustrative Embodiments should be read in conjunction with the accompanying Drawings, wherein:

FIG. 1 is a perspective of a hand-supportable laser scanning bar code symbol reading system employing a conventionally-elongated laser scanning beam for reading bar code symbols;

FIG. 2A1 is a graphical representation of a good or perfect quality UPC bar code symbol being scanned by a conventionally-elongated laser scanning beam produced from the hand-supportable laser scanning bar code symbol reading system of FIG. 1;

2A2 is a graphical representation of the reflectance profile produced by a conventionally-elongated laser scanning beam projected from the hand-supportable laser scanning bar code symbol reading system of FIG. 1, and used to scan the UPC bar code symbol shown in FIG. 2A1;

FIG. 2B1 is a graphical representation of a degraded UPC bar code symbol being scanned by a conventionally-elongated laser scanning beam produced from the hand-supportable laser scanning bar code symbol reading system of FIG. 1;

2B2 is a graphical representation of the reflectance profile produced by a conventionally-elongated laser scanning beam projected from the hand-supportable laser scanning bar code symbol reading system of FIG. 1, and used to scan the degraded UPC bar code symbol shown in FIG. 2B1;

FIG. 2C1 is a graphical representation of a the second layer of a perfect stacked 2D bar code symbol being scanned by a conventionally-elongated laser scanning beam produced from the hand-supportable laser scanning bar code symbol reading system of FIG. 1;

2C2 is a graphical representation of the reflectance profile produced by a conventionally-elongated laser scanning beam projected from the hand-supportable laser scanning bar code symbol reading system of FIG. 1, and used to scan the stacked 2D bar code symbol shown in FIG. 2C1;

FIG. 2D is a graphical representation showing the elongation ratio (Y/X) of a conventionally-elongated laser beam a function of location along beam travel direction (Z);

FIG. 3 is a perspective of a hand-supportable laser scanning bar code symbol reading system employing a dynamically-elongated laser scanning beam for reading bar code symbols, in accordance with the present disclosure;

FIG. 4 is a schematic block diagram describing the primary system components within the hand-supportable laser scanning bar code symbol reading system of FIG. 3, including a dynamically-elongated laser beam production module (i.e. an electro-optical module for producing a dynamically-elongated laser scanning beam) during each laser scanning bar code symbol reading cycle;

FIG. 4A is a schematic block diagram of a first illustrative embodiment of an electro-optical module for producing a dynamically-elongated laser scanning beam, employing an assembly of a multi-cavity visible laser diode (VLD), a collimating lens, an aperture stop, and an elongation (i.e. cylindrical lens);

FIG. 4B is a schematic block diagram of a second illustrative embodiment of an electro-optical module for producing a dynamically-elongated laser scanning beam, employing an assembly of a visible laser diode (VLD), a collimating lens, an aperture stop, and an adaptive/variable-focus cylindrical lens element;

FIG. 5A is a perspective view of the dynamically-elongated laser beam production module based on the design illustrated in FIG. 4A, for use in the hand-supportable laser scanning bar code symbol reading system of FIG. 3;

FIG. 5B is an exploded perspective view of a dynamically-elongated laser beam production module shown in FIG. 5A, for use in the hand-supportable laser scanning bar code symbol reading system of FIG. 3;

FIG. 5C is an exploded side view of the dynamically-elongated laser beam production module shown in FIGS. 5A and 5B, for use in the hand-supportable laser scanning bar code symbol reading system of FIG. 3;\

FIG. 5D is a cross-sectional view of the fully assembled dynamically-elongated laser beam production module shown in FIGS. 5A through 5C, for use in the hand-supportable laser scanning bar code symbol reading system of FIG. 3;

FIG. 5E is a cross-sectional view of an alternative embodiment of a fully assembled dynamically-elongated laser beam production module based on the design shown in FIG. 4A, but using a reflective-type cylindrical (i.e. beam elongating) optical element in lieu of a refractive-type cylindrical lens, in the hand-supportable laser scanning bar code symbol reading system of FIG. 3;

FIG. 6 is a schematic diagram of a dynamically-elongated laser beam production module based on the design illustrated in FIG. 4B, and employing a variable-focus deformable or liquid crystal (LC) cylindrical lens element, for use in the hand-supportable laser scanning bar code symbol reading system of FIG. 3;

FIG. 7 is a schematic representation of an optical model for the laser scanning beam production module employed in the hand-supportable laser scanning bar code symbol reading system of FIG. 3, illustrating, at an instant in time, the 1/e² scan and cross scan dimensions of the beam profile of a dynamically-elongated laser scanning beam being projected onto and scanned across a degraded bar code symbol;

FIG. 7A is a schematic representation of a linear bar code symbol at a moment of scanning by the dynamically-elongated laser scanning beam produced from the laser scanning bar code symbol reading system of FIG. 3, illustrating the x and y scanning reference directions and definition of the Elongation Ratio (ER=Y/X);

FIG. 7B is a graphical representation of normalized intensity distribution plot of the height (y) dimension (i.e. height) of the dynamically-elongated laser beam taken at the x-waist location along the direction of propagation (i.e. z axis) and produced when laser cavity no. 1 is activated in the laser scanning bar code symbol reading of FIG. 3;

FIG. 7C is a graphical representation of normalized intensity distribution plot of the width (x) dimension (i.e. width) of the dynamically-elongated laser beam taken at the x-waist location along the direction of propagation (i.e. z axis) and produced when laser cavity no. 1 is activated in the laser scanning bar code symbol reading system of FIG. 3;

FIG. 7D is a graphical representation of normalized intensity distribution plot of the height (y) dimension (i.e. height) of the dynamically-elongated laser beam taken at the x-waist location along the direction of propagation (i.e. z axis) and produced when laser cavity nos. 1 and 2 are activated in the laser scanning bar code symbol reading system of FIG. 3;

FIG. 7E is a graphical representation of normalized intensity distribution plot of the width (x) dimension (i.e. width) of the dynamically-elongated laser beam taken at the x-waist location along the direction of propagation (i.e. z axis) and produced when laser cavity nos. 1 and 2 are activated in the laser scanning bar code symbol reading system of FIG. 3;

FIG. 7F is a graphical representation of normalized intensity distribution plot of the height (y) dimension (i.e. height) of the dynamically-elongated laser beam taken at the x-waist location along the direction of propagation (i.e. z axis) and produced when laser cavity nos. 1, 2 and 3 are activated in the laser scanning bar code symbol reading system of FIG. 3;

FIG. 7G is a graphical representation of normalized intensity distribution plot of the width (x) dimension (i.e. width) of the dynamically-elongated laser beam taken at the x-waist location along the direction of propagation (i.e. z axis) and produced when laser cavity nos. 1, 2 and 3 are activated in the laser scanning bar code symbol reading system of FIG. 3;

FIG. 7H is a graphical representation of normalized intensity distribution plot of the height (y) dimension (i.e. height) of the dynamically-elongated laser beam taken at the x-waist location along the direction of propagation (i.e. z axis) and produced when laser cavity nos. 1, 2, 3 and 4 are activated in the laser scanning bar code symbol reading system of FIG. 3;

FIG. 7I is a graphical representation of normalized intensity distribution plot of the width (x) dimension (i.e. width) of the dynamically-elongated laser beam taken at the x-waist location along the direction of propagation (i.e. z axis) and produced when laser cavity nos. 1, 2, 3 and 4 are activated in the laser scanning bar code symbol reading system of FIG. 3;

FIG. 7J is a graphical representation illustrating the 1/e² beam diameter along the width (x) dimension of the dynamically-elongated laser scanning beam produced from the laser scanning bar code symbol reading system of FIG. 3, when particular laser cavities are activated, plotted as a function of distance along the direction of propagation (z) of the laser scanning beam;

FIG. 7K1 is a graphical representation illustrating the 1/e² beam diameter along the height (y) dimension of the dynamically-elongated laser scanning beam produced from the laser scanning bar code symbol reading system of FIG. 3, when particular laser cavities are activated, plotted as a function of distance along the direction of propagation (z) of the laser scanning beam, without the use of beam elongation optics after the light beam collimating optics;

FIG. 7K2 is a graphical representation illustrating the 1/e² beam diameter along the height (y) dimension of the dynamically-elongated laser scanning beam produced from the laser scanning bar code symbol reading system of FIG. 3, when particular laser cavities are activated, plotted as a function of distance along the direction of propagation (z) of the laser scanning beam, with the use of beam elongation optics after the light beam collimating optics;

FIG. 7L is a graphical representation showing the elongation ratio (Y/X) of a dynamically-elongated laser beam, when particular laser cavities are activated in the laser scanning bar code symbol reading system of FIG. 3, plotted as a function of location along beam travel direction (Z);

FIG. 7M is a graphical representation showing the elongation ratio (Y/X) of a dynamically-elongated laser beam, produced when particular laser cavities are activated in the laser scanning bar code symbol reading system of FIG. 3, plotted as a function of location along beam travel direction (Z), but without the use of beam elongating optics after the light beam collimating optics;

FIG. 8 is a flow chart describing the steps involved during the operation of the hand-supportable laser scanning bar code symbol reading system of FIG. 3;

FIG. 9 is a flow chart describing a first exemplary control process for driving the multi-cavity VLD shown in FIG. 4A (or adaptive variable-focus cylindrical lens shown in FIG. 4B) employed in the hand-supportable laser scanning bar code symbol reading system of FIG. 3, during each trigger event indicated in FIG. 8, wherein a single (1) laser beam sweep occurs each 0.01 [Seconds] and that the SNR changes every laser beam sweep, and wherein the X-dimension (beam width) is constant over time while the Y-dimension varies over time in multiples of sweep time;

FIG. 10 is a flow chart describing a second exemplary control process for driving the multi-cavity VLD shown in FIG. 4A (or adaptive variable-focus cylindrical lens shown in FIG. 4B) employed in the hand-supportable laser scanning bar code symbol reading system of FIG. 3, during each trigger event indicated in FIG. 8, wherein a single (1) laser beam sweep occurs each 0.01 [Seconds] and that the SNR changes every laser beam sweep, and wherein the X-dimension (beam width) is constant over time while the Y-dimension varies over time in multiples of sweep time;

FIG. 11 is a schematic representation showing the laser beam elongation ratio (ER) vs. time characteristics at the x beam waist location of laser beam produced from a four-cavity VLD after beam collimating optics and without beam elongation optics;

FIG. 12 is a schematic representation showing the laser beam elongation ratio (ER) vs. time characteristics, at the x beam waist location of laser beam produced from a four-cavity VLD in the hand-supportable laser scanning bar code symbol reading system of FIG. 3, after beam elongation optics;

FIG. 13 is a schematic representation showing the signal to noise ratio (SNR) vs. time characteristics, at the x beam waist location of laser beam produced from a four-cavity VLD in the hand-supportable laser scanning bar code symbol reading system of FIG. 3, after beam collimating optics and without beam elongation optics;

FIG. 14 is a schematic representation showing the SNR vs. time at the x beam waist location of laser beam produced from a four-cavity VLD in the hand-supportable laser scanning bar code symbol reading system of FIG. 3, after beam elongation optics;

FIG. 15A is a graphical representation of a perfect UPC bar code symbol being scanned by a dynamically-elongated (DE) laser scanning beam produced from the hand-supportable laser scanning bar code symbol reading system of FIG. 3;

FIG. 15B is a graphical representation of the reflectance profile produced by a dynamically-elongated (DE) laser scanning beam projected from the hand-supportable laser scanning bar code symbol reading system of FIG. 3, when used to scan the perfect UPC bar code symbol shown in FIG. 15A;

FIG. 16A is a graphical representation of a degraded UPC bar code symbol being scanned by a dynamically-elongated (DE) laser scanning beam produced from the hand-supportable laser scanning bar code symbol reading system of FIG. 3;

FIG. 16B is a graphical representation of the reflectance profile produced by a dynamically-elongated (DE) laser scanning beam projected from the hand-supportable laser scanning bar code symbol reading system of FIG. 3, when used to scan the degraded UPC bar code symbol shown in FIG. 16A;

FIG. 17A is a graphical representation of the second layer of a good quality stacked 2D bar code symbol being scanned by a dynamically-elongated (DE) laser scanning beam produced from the hand-supportable laser scanning bar code symbol reading system of FIG. 3, where the height (y) dimension of the dynamically-elongated laser beam on the scanning plane is greater than the height dimension of the bar elements in the second layer of the 2D stacked bar code symbol; and

FIG. 17B is a graphical representation of the reflectance profile produced by a dynamically-elongated laser scanning beam projected from the hand-supportable laser scanning bar code symbol reading system of FIG. 3, when used to scan the stacked 2D bar code symbol shown in FIG. 17A.

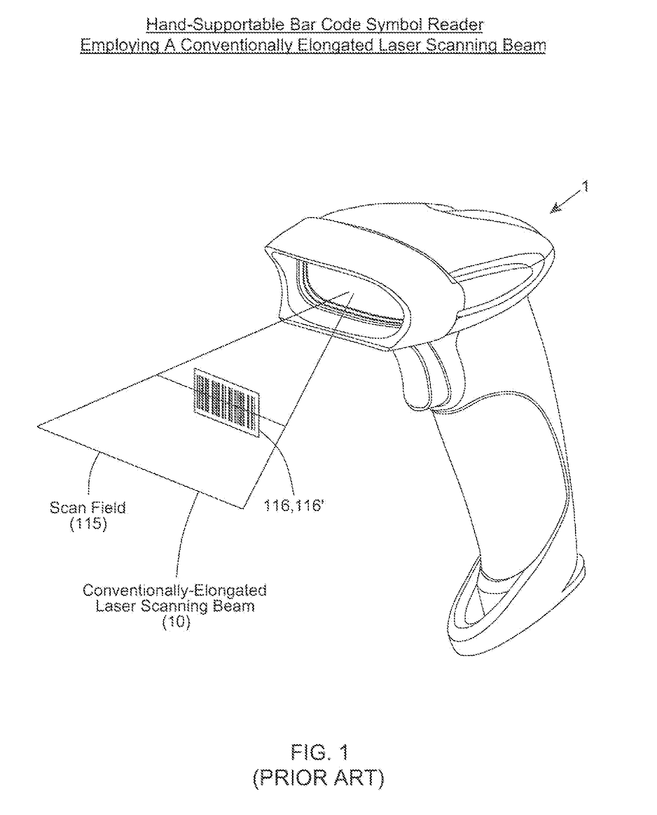

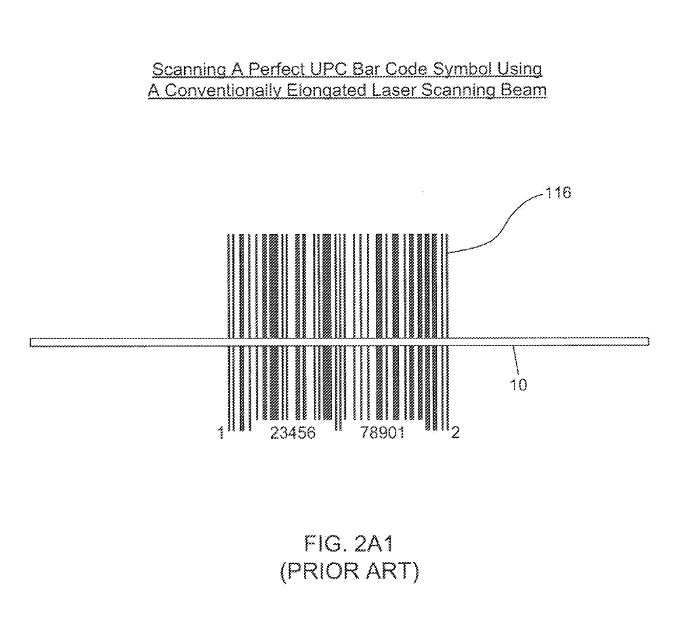

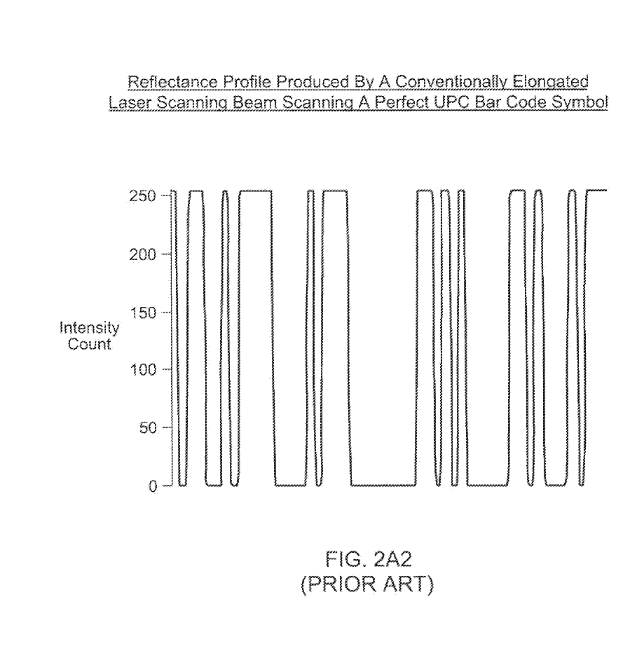

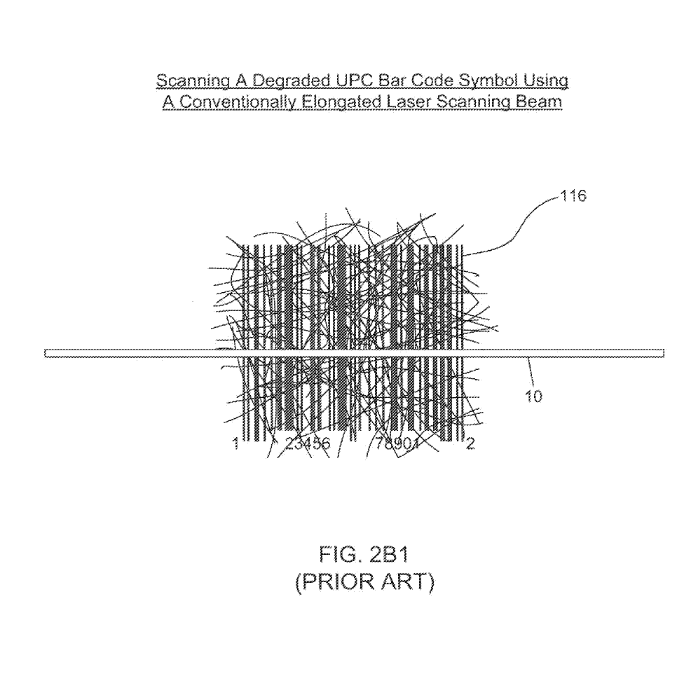

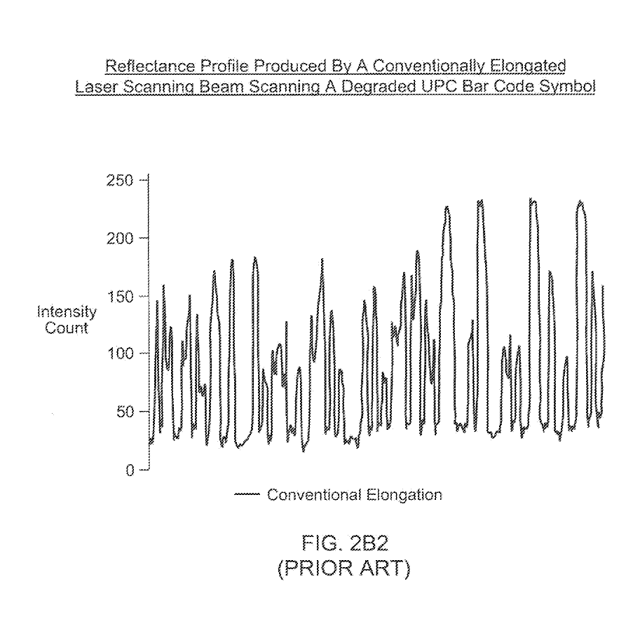

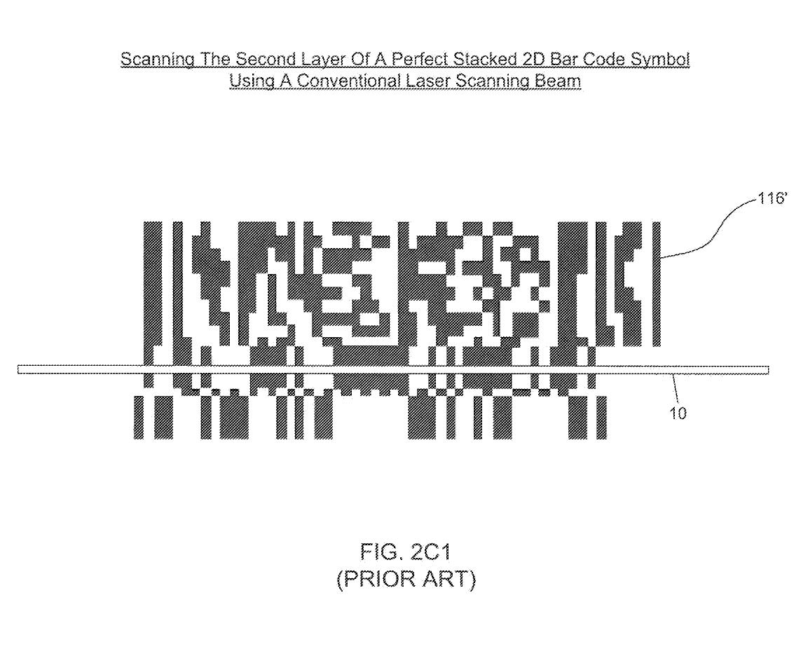

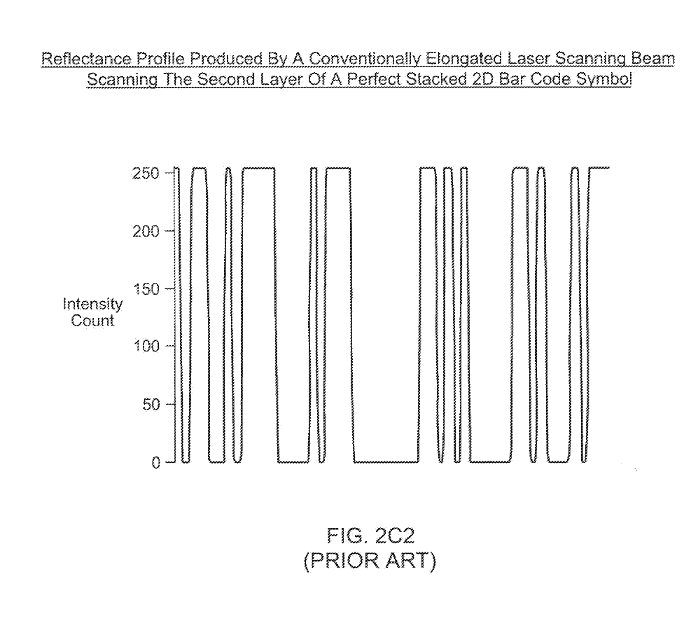

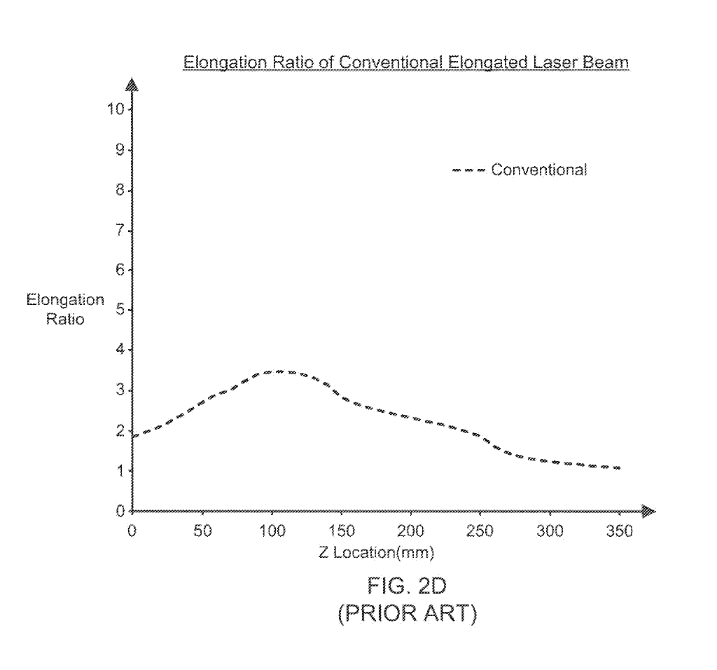

### DETAILED DESCRIPTION OF THE ILLUSTRATIVE EMBODIMENTS OF THE PRESENT DISCLOSURE

Referring to the figures in the accompanying Drawings, the illustrative embodiment of the digital imaging system will be described in greater detail, wherein like elements will be indicated using like reference numerals.

### Specification of the Bar Code Symbol Reading System of the Illustrative Embodiment Employing an Dynamically-Elongated Laser Scanning Beam to Enhance Reading Performance of Poor Quality and Damaged Bar Code Symbols

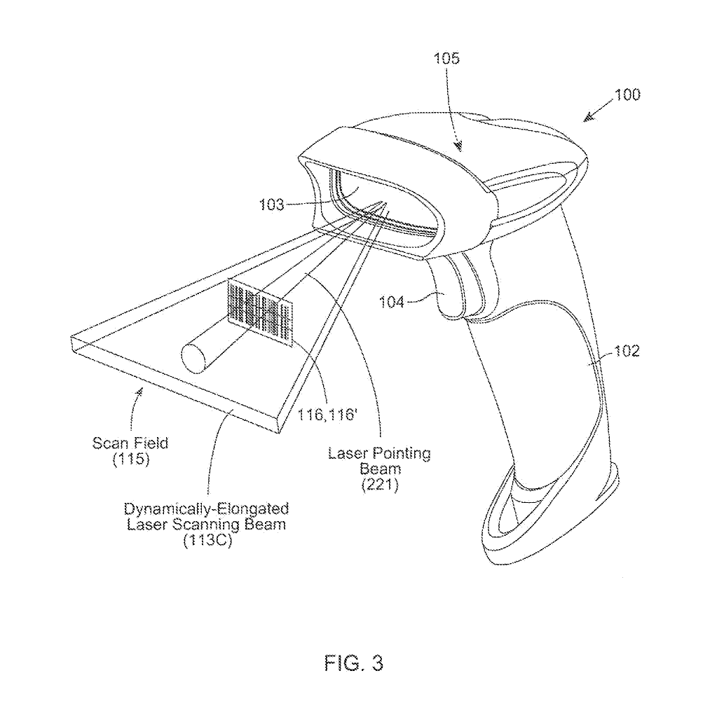

Referring now to FIGS. 3 through 8, an illustrative embodiment of a manually-triggered/automatically-triggered hand-supportable laser scanning bar code symbol reading system 1 will be described in detail.

It has been discovered that by dynamically-varying the elongation ratio (ER) of a laser scanning beam over extreme values, during each bar code symbol reading/scanning cycle, however triggered, effectively solves the problem of reading poor quality and damaged barcodes. In the illustrative embodiments disclosed herein, this is achieved using a laser scanning beam that is dynamically elongated in the cross scan (Y) dimension, during each bar code symbol reading cycle, so as to average out defects in the laser scanned bar code symbol structure, while allowing more flexibility on the tilt angle between the laser scanning beam and the bar code symbol being read.

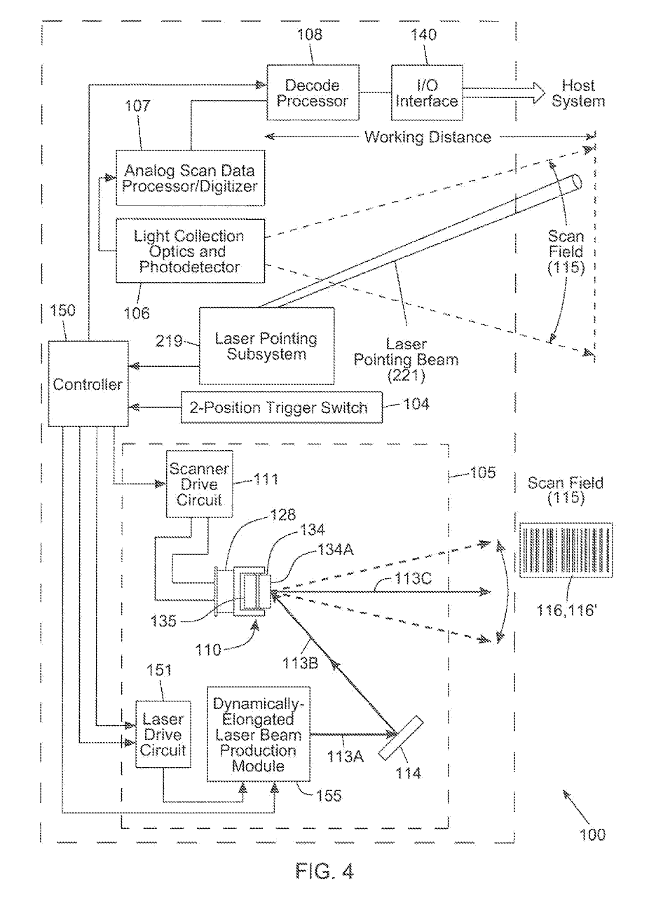

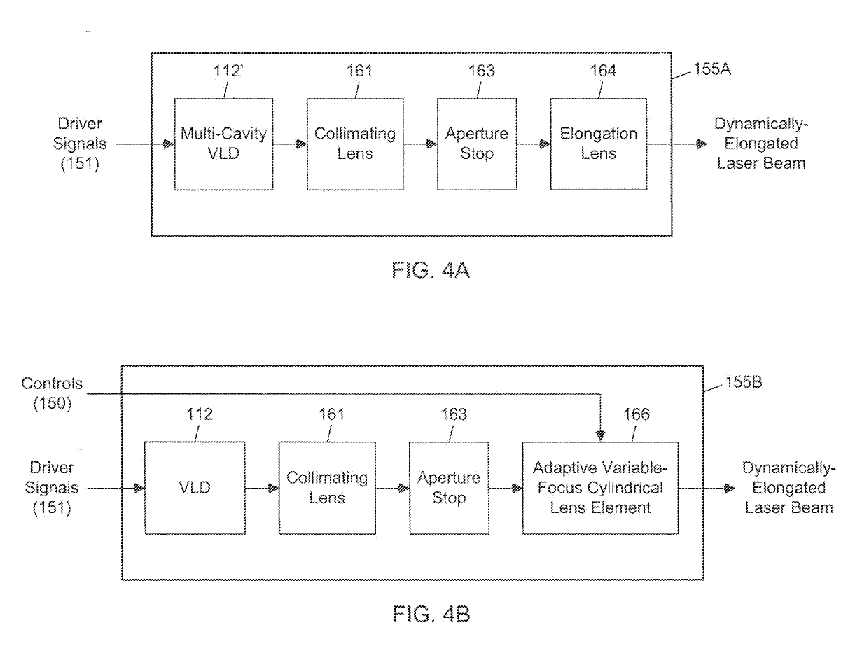

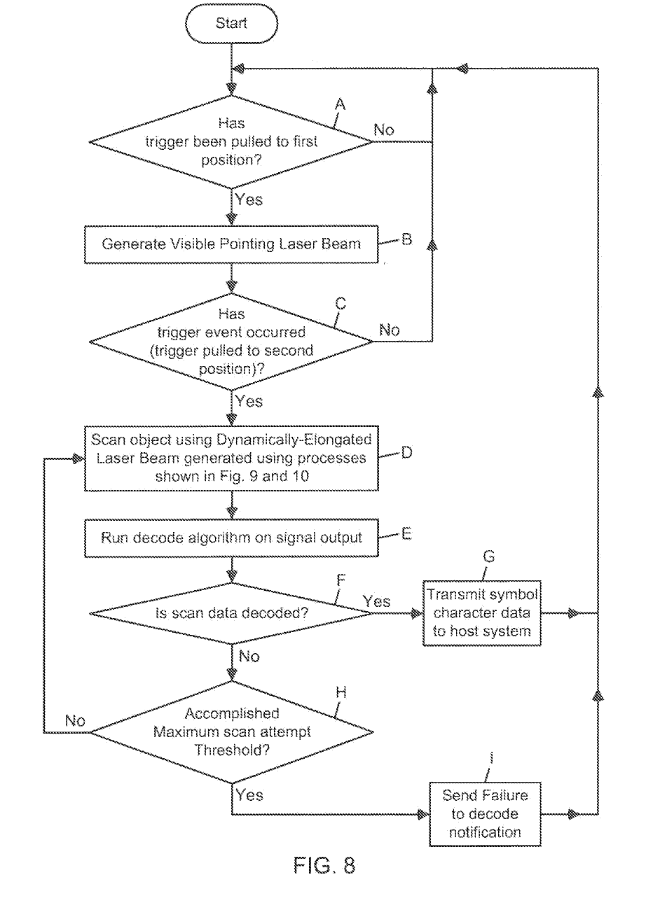

As shown in FIGS. 3 and 4, the laser scanning bar code symbol reading system 100 comprises: a hand-supportable housing 102 having a head portion and a handle portion supporting the head portion; a light transmission window 103 integrated with the head portion of the housing 102; a laser pointing subsystem 219 for generating a visible pointing beam within the laser scanning field, as shown in FIG. 3; a laser scanning module 105, for repeatedly scanning, across the laser scanning field, a visible dynamically-elongated laser beam 113 generated by an electronically-controlled dynamically-elongated laser beam production module 155; wherein the laser scanning module 105 also includes a laser drive circuit 151 for receiving control signals from system controller 150, and in response thereto, generating and delivering laser (diode) drive current signals to the laser source 112, to produce a dynamically-elongated laser scanning beam during each laser scanning bar code symbol reading cycle, described in FIG. 8; a manually-actuated two-position trigger switch 104 integrated with the handle portion of the housing, for activating the laser pointing subsystem 219 upon generating a first trigger event when the switch is pulled to its first position, and also activating the laser scanning module 105 with a laser scanning field 115 upon generating a second trigger event when the trigger switch is pulled to its second position; light collection optics 106 for collecting light reflected/scattered from scanned object in the scanning field, and a photo-detector for detecting the intensity of collected light and generating an analog scan data signal corresponding to said detected light intensity during scanning operations; an analog scan data signal processor/digitizer 107 for processing the analog scan data signals and converting the processed analog scan data signals into digital scan data signals, which are then converted into digital words representative of the relative width of the bars and spaces in the scanned code symbol structure; programmed decode processor 108 for decode processing digitized data signals, and generating symbol character data representative of each bar code symbol scanned by dynamically-elongated laser scanning beam 114B; an input/output (I/O) communication interface module 140 for interfacing with a host communication system and transmitting symbol character data thereto via wired or wireless communication links that are supported by the symbol reading system and host system; and a system controller 150 for generating the necessary control signals for controlling operations within the laser scanning bar code symbol reading system 1.

As shown in FIG. 4, the laser scanning module 105 comprises a number of subcomponents, namely: laser scanning assembly 110 with an electromagnetic coil 128 and rotatable scanning element (e.g. mirror) 134 supporting a lightweight reflective element (e.g. mirror) 134A; a coil drive circuit 111 for generating an electrical drive signal to drive the electromagnetic coil 128 in the laser scanning assembly 110; a dynamically-elongated laser beam production module 155 for producing a dynamically-elongated laser beam 113; a beam deflecting mirror 114 for deflecting the dynamically-elongated laser beam 113, as incident beam 114A towards the mirror component of the laser scanning assembly 110, which sweeps the deflected laser beam 114B across the laser scanning field and a bar code symbol 116 that might be simultaneously present therein during system operation; and a start of scan/end of scan 136 detector operably connected to controller 150, providing timing control signals to controller 150 upon the occurrence of each start of scan event and end of scan event, occurring in the laser scanning assembly 10.

As shown in FIG. 4, the laser scanning module 105 is typically mounted on an optical bench, printed circuit (PC) board or other surface where the laser scanning assembly is also, and includes a coil support portion 110 for supporting the electromagnetic coil 128 (in the vicinity of the permanent magnet 135) and which is driven by a drive circuit 111 so that it generates magnetic forces on opposite poles of the permanent magnet 135, during scanning assembly operation.

Optionally, a laser pointing subsystem (not shown) can be mounted in the front of its light transmission window 103 so that the IR light transmitter and IR light receiver components of subsystem have an unobstructed view of an object within the laser scanning field of the system, as shown in FIG. 3. In such an alternative embodiment, the IR object presence detection module can transmit into the scanning field 115, IR signals having a continuous low-intensity output level, or having a pulsed higher-intensity output level, which may be used under some conditions to increase the object detection range of the system. In another alternative embodiments, the IR light transmitter and IR light receiver components can be realized as visible light (e.g. red light) transmitter and visible light (e.g. red light) receiver components, respectively, well known in the art. Typically the object detecting light beam will be modulated and synchronously detected, as taught in U.S. Pat. No. 5,340,971, incorporated herein by reference.

When operated in its manually triggered mode, the IR-based object detection subsystem would be deactivated, and manually-actuated trigger switch 104 would be operable to generate trigger events when the user manually pulls the trigger switch 104 to its first trigger position to generate a visible pointing beam 221, and then to its second trigger position, when a code symbol is aligned within its laser scanning field and the symbol is ready to be laser scanned.

FIG. 4A shows a first illustrative embodiment of an electro-optical module 155A for producing a dynamically-elongated laser scanning beam, comprising: a multi-cavity visible laser diode (VLD) 112′, a collimating lens 161, an aperture stop 163, and an elongation (i.e. cylindrical lens) 164.

FIG. 4B shows a second illustrative embodiment of an electro-optical module 155B for producing a dynamically-elongated laser scanning beam, comprising: a visible laser diode (VLD) 112, a collimating lens 161, an aperture stop 163, and an adaptive/variable-focus cylindrical lens element 166.

### First Embodiment of the Dynamically-Elongated Laser Beam Production Module

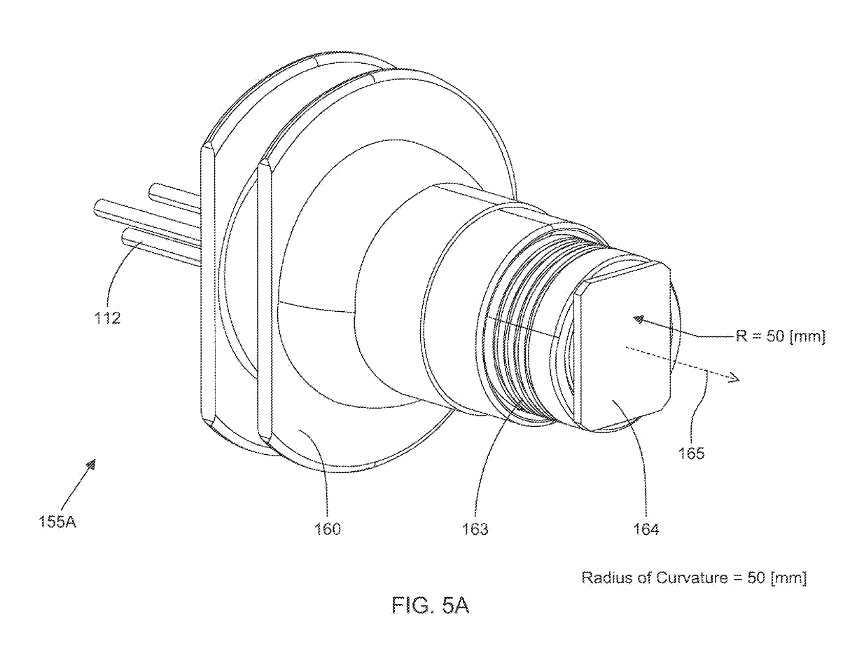

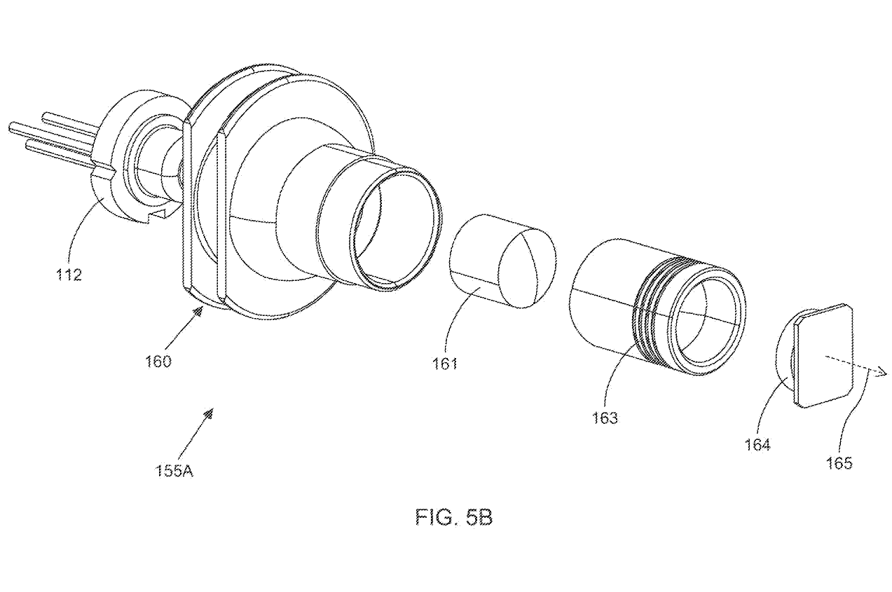

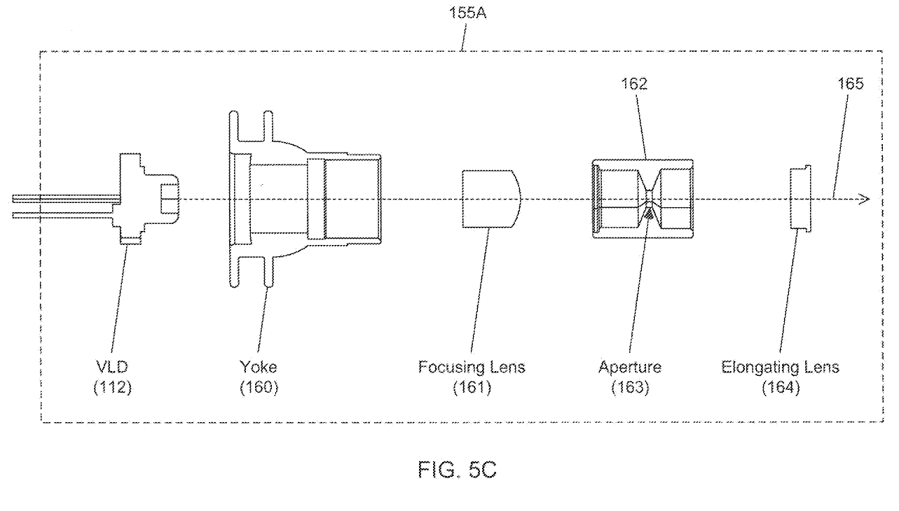

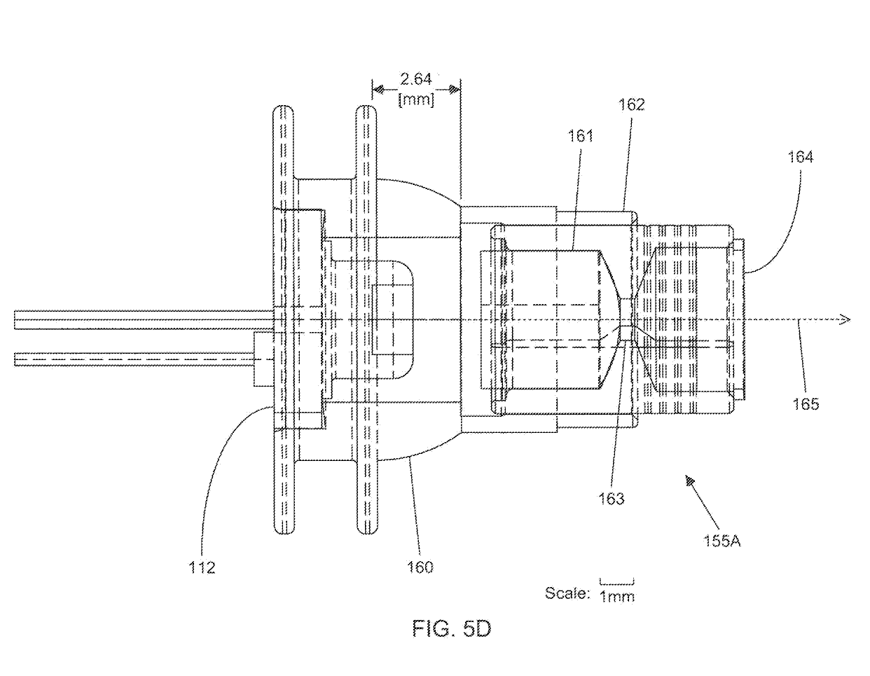

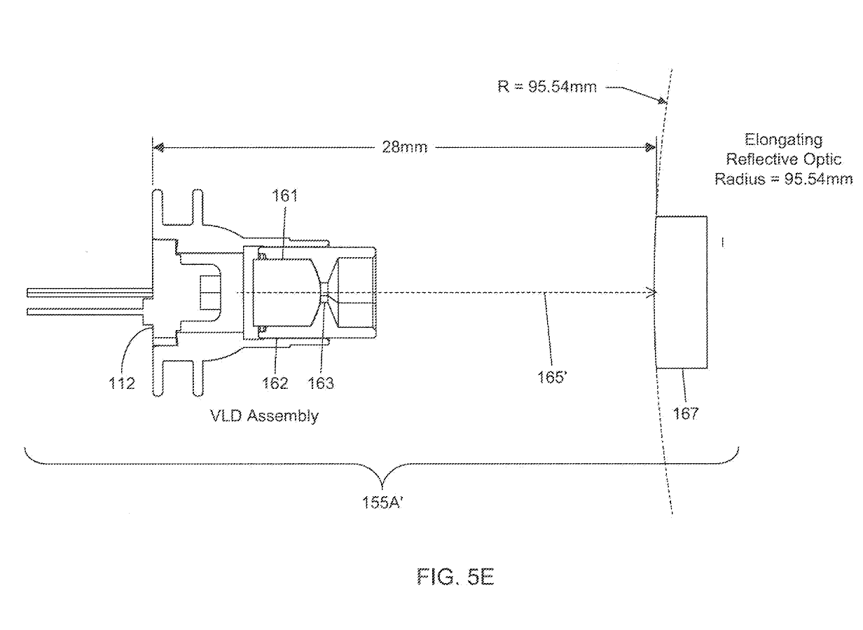

FIGS. 5A and 5D shows a dynamically-elongated laser beam production module based on the design illustrated in FIG. 4A, for use in the hand-supportable laser scanning bar code symbol reading system of FIG. 3. As shown, the dynamically-elongated laser beam production module 155A comprises: a multi-cavity laser source 112 (e.g. multi-cavity VLD), installed in a yoke assembly 160, having a focusing/collimating lens (i.e. 4.0 [mm] focal length) 161; a lens holder 162 for holding focusing/collimating lens 161, and an aperture stop 163 having a 0.94 [mm] circular diameter, and also holding elongating cylindrical lens (having a radius of curvature of 50 [mm]) 163 along the common optical axis 165 of focusing lens 161, elongating lens 163, and VLD 112, as shown in FIG. 5D.

A primary object of laser beam production module 155A is to produce a laser beam 113 (114B) having an Elongation Ratio (ER), which dynamically changes between extreme values during each laser scanning cycle (e.g. trigger event) so as to increase the performance of the laser scanning bar code symbol reading system attempting to read different types of degraded bar code symbols, under different operating conditions.

As used herein and in the claims, the elongation ratio (ER) of the laser scanning beam shall be defined as Y/X, where: (i) for any point within the working range of the laser scanning bar code scanner (i.e. along the Z direction); (ii) Y indicates the laser beam height measured in the cross-scan direction or Y dimension laser beam, and X indicates the laser beam width measured in the scan direction or X dimension of the laser beam; and (iii) the laser beam height (Y) and laser beam diameter (X) are measured at 1/e2 intensity clip level.

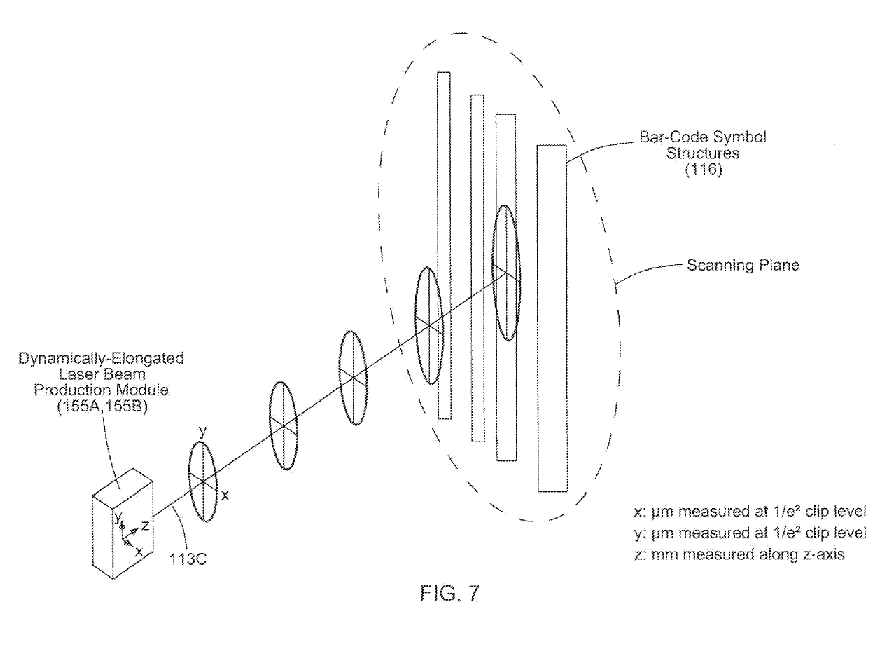

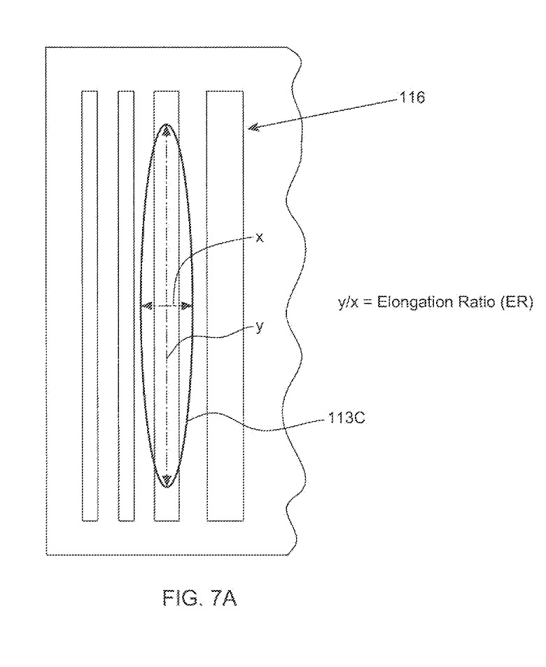

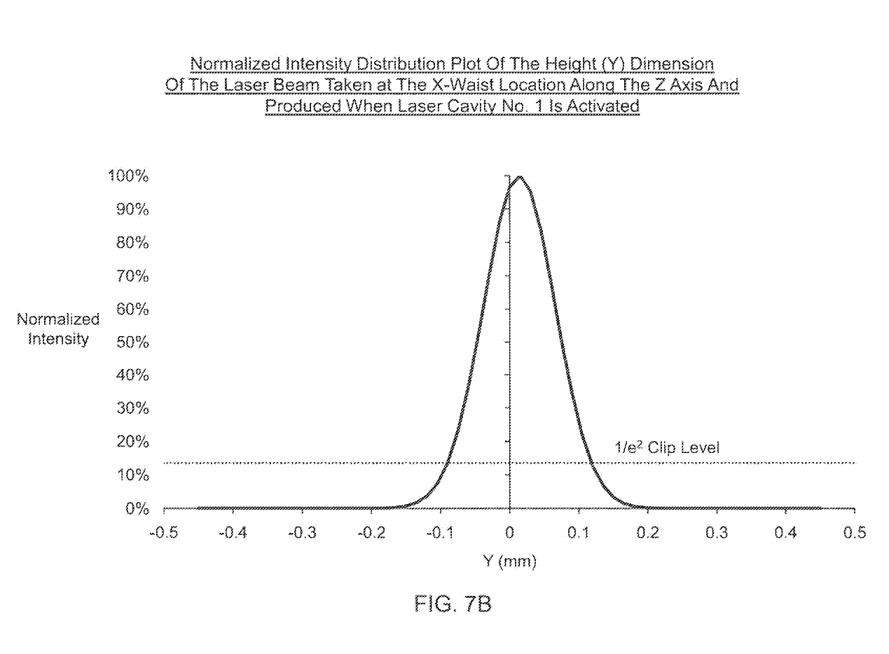

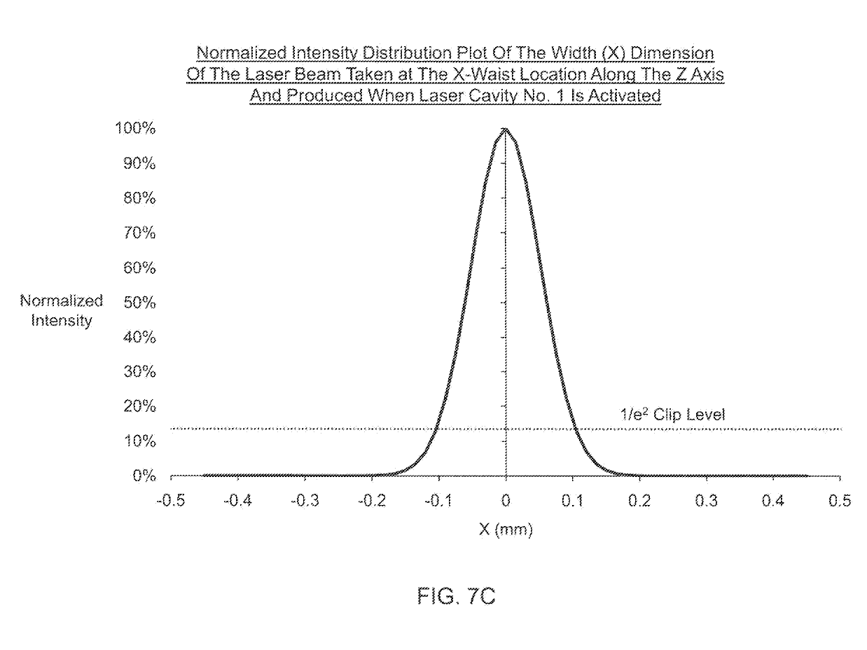

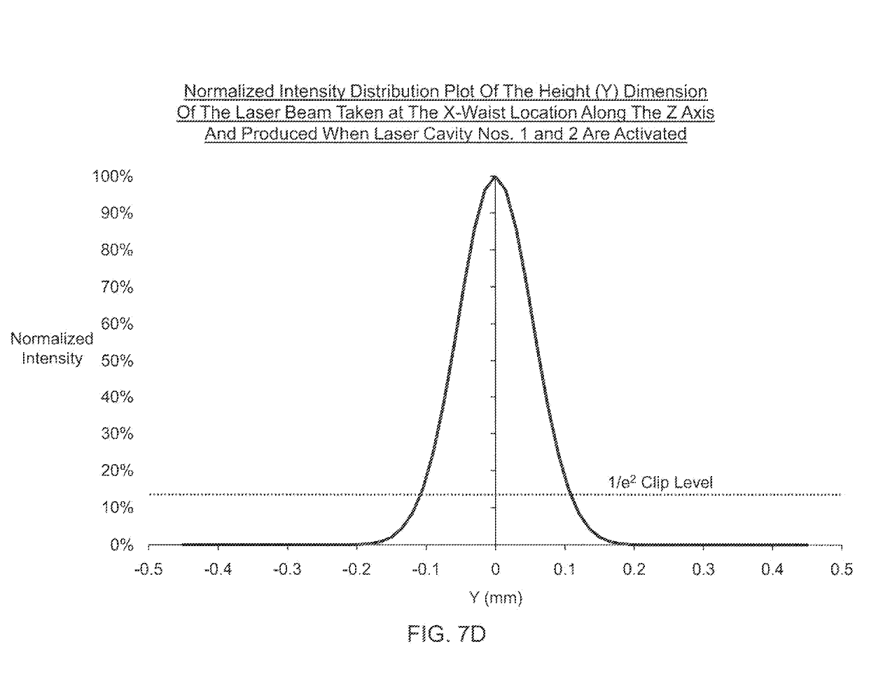

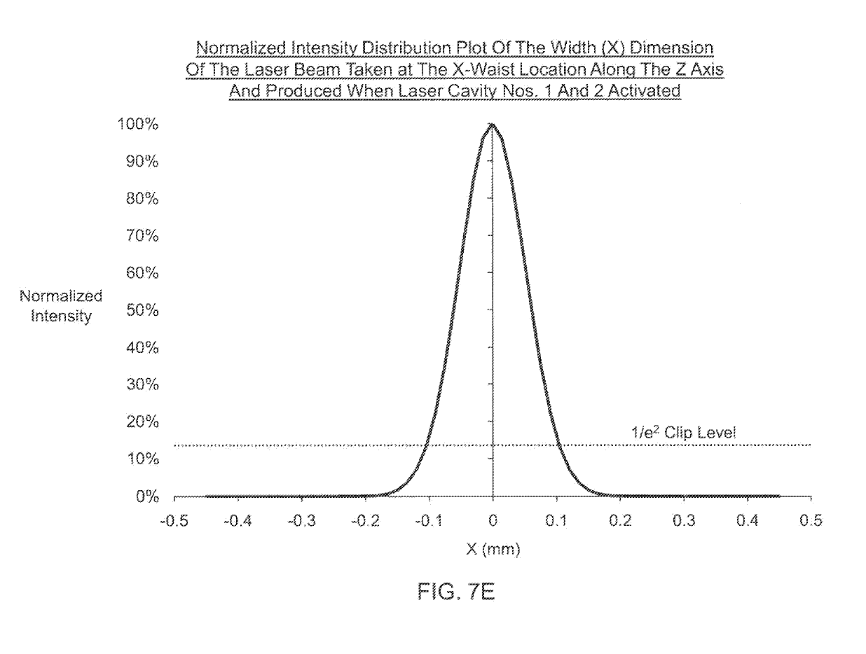

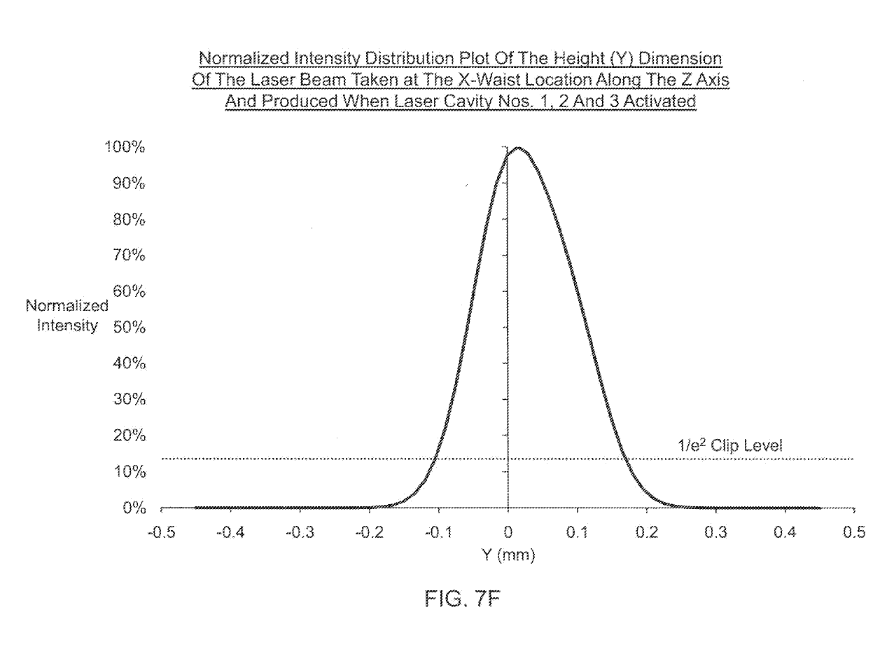

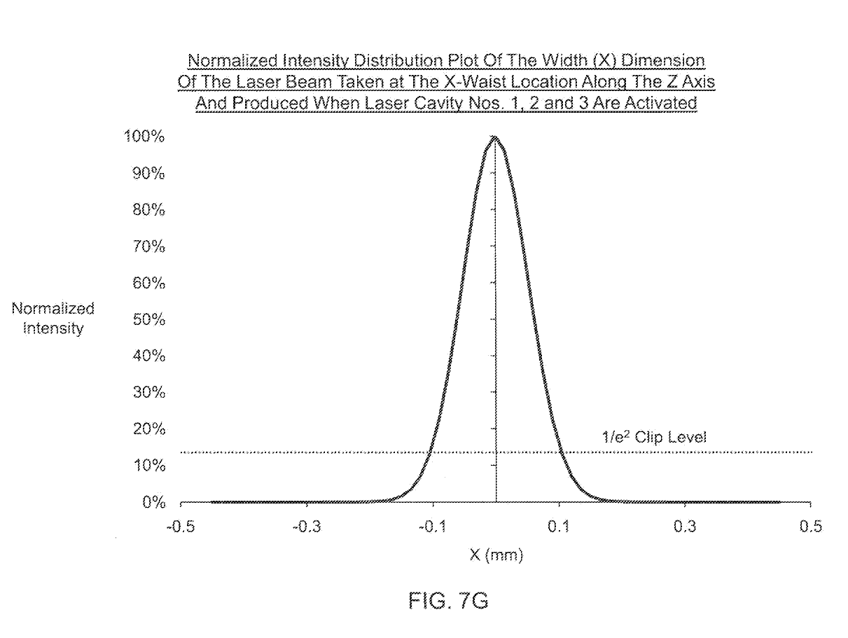

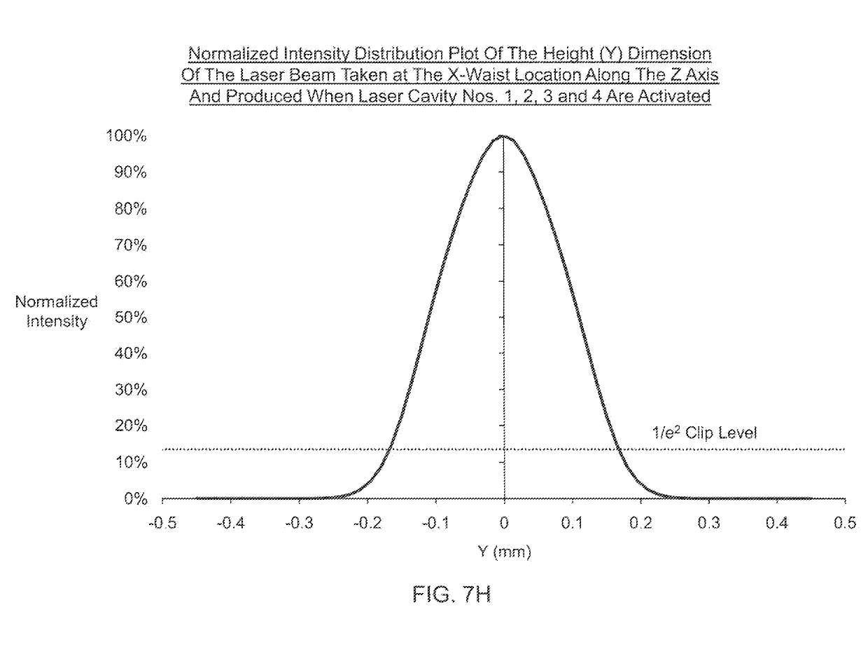

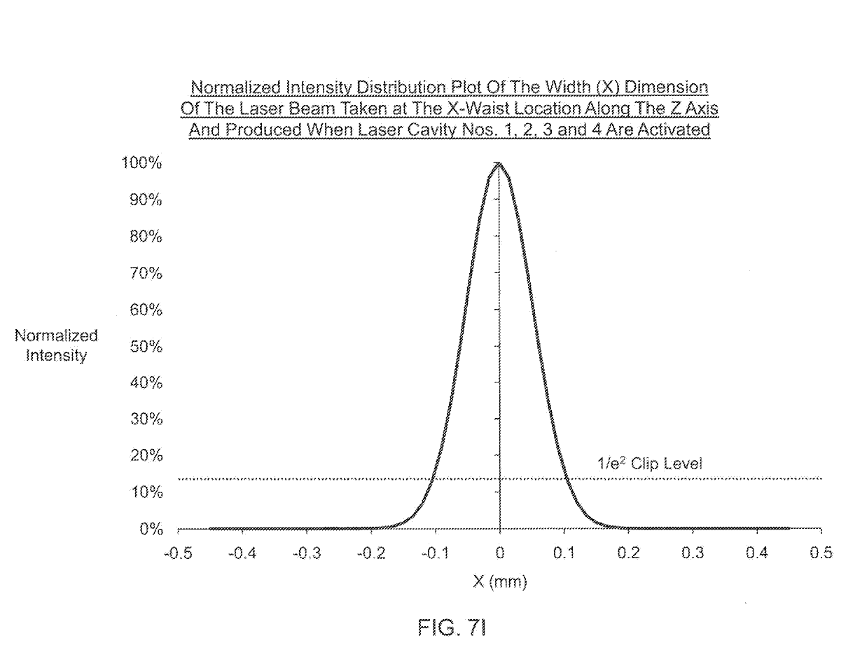

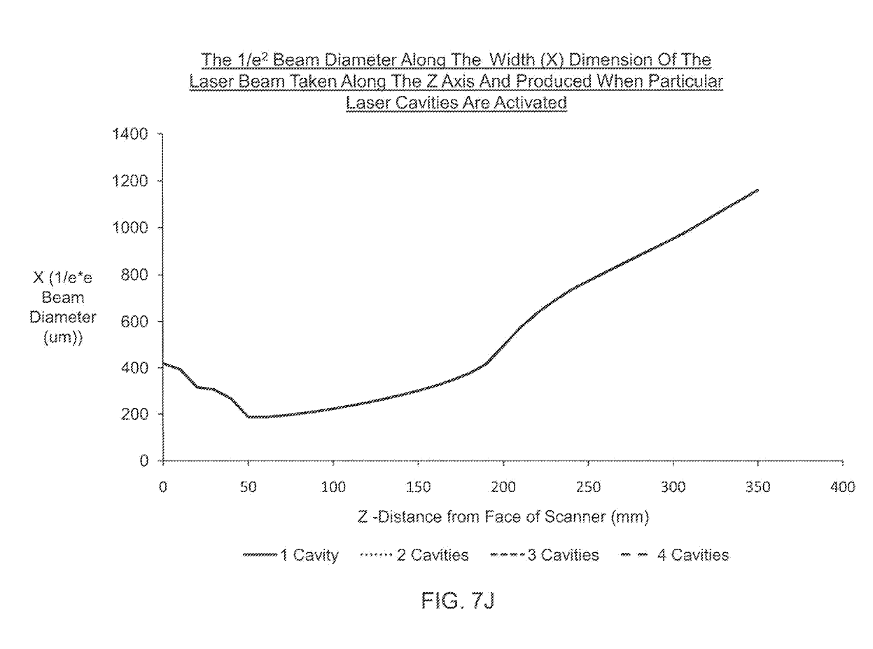

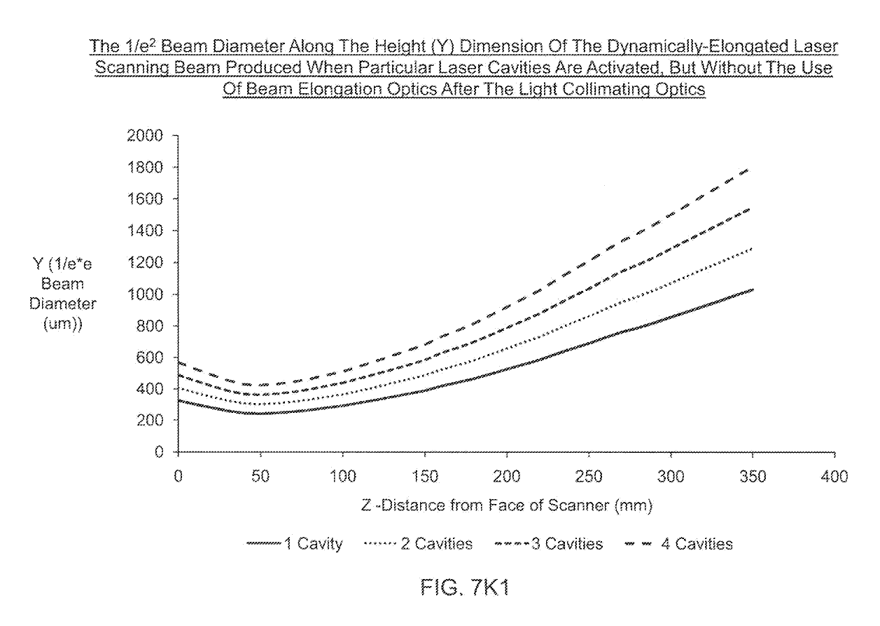

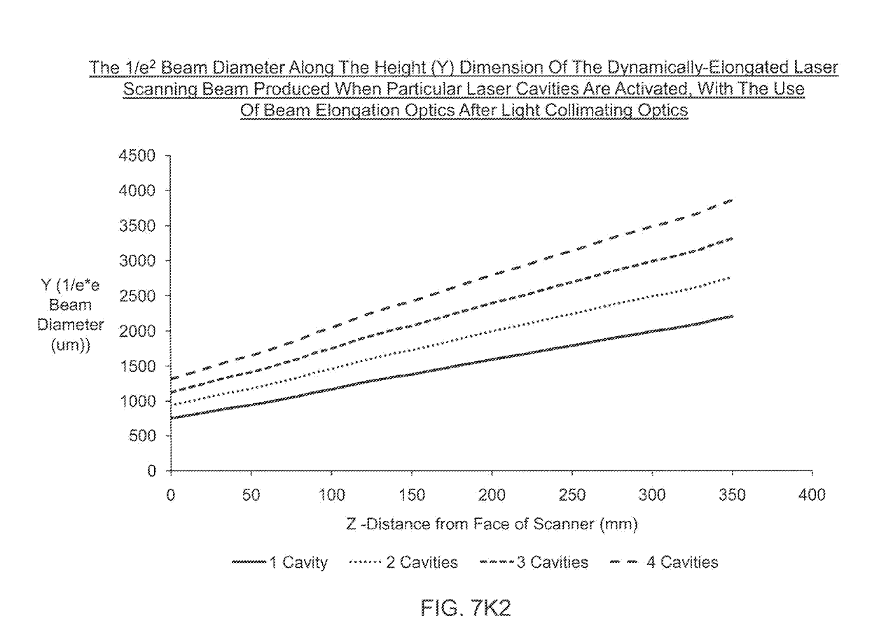

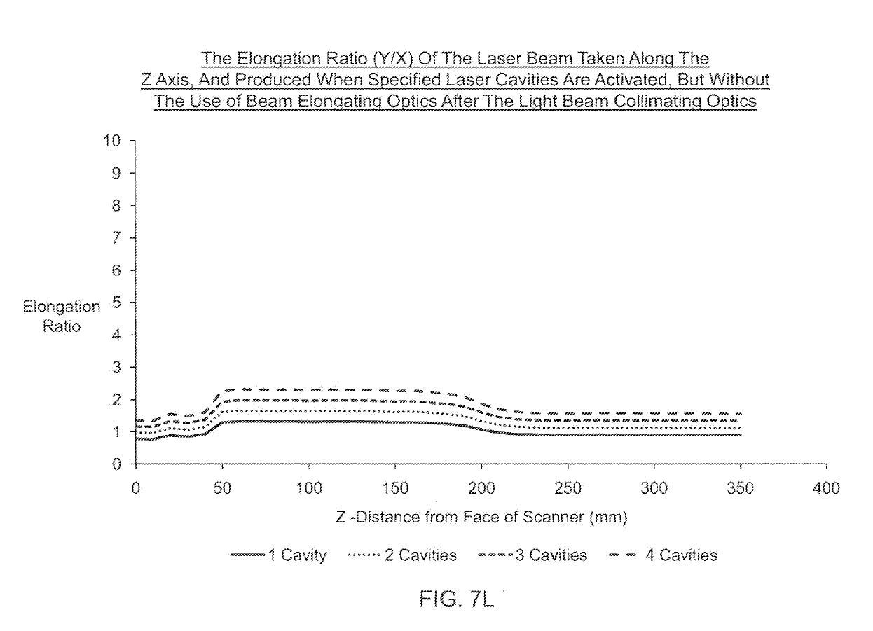

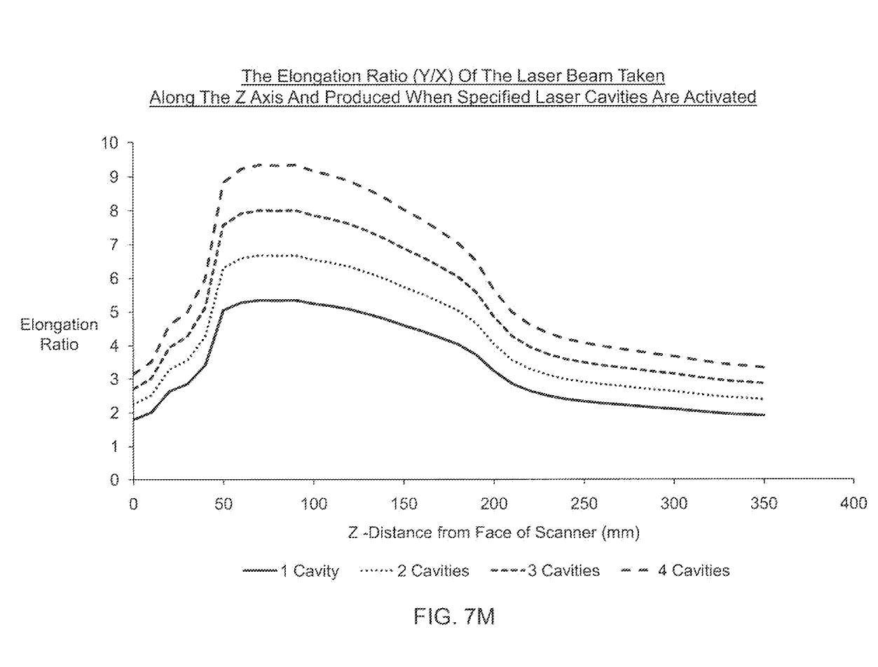

By definition, the beam waist in the scan (x) direction is the smallest point of the laser beam in the x dimension, and as indicated in the illustrative embodiment of FIG. 7J, the beam waist is located around 60.0 [mm] in the Z direction. As indicated in FIG. 7K2, there is no beam waist in the Y dimension as the dynamically-elongated laser beam 114B is completely divergent along the Z dimension. As indicated in FIG. 7M, the extremely elongated laser beam 113 has extreme elongation around 1.0 inch from the face of the scanner, out to about 12.0 inches therefrom, with peak elongation occurring at the waist of the beam profile at a value of 9.2.

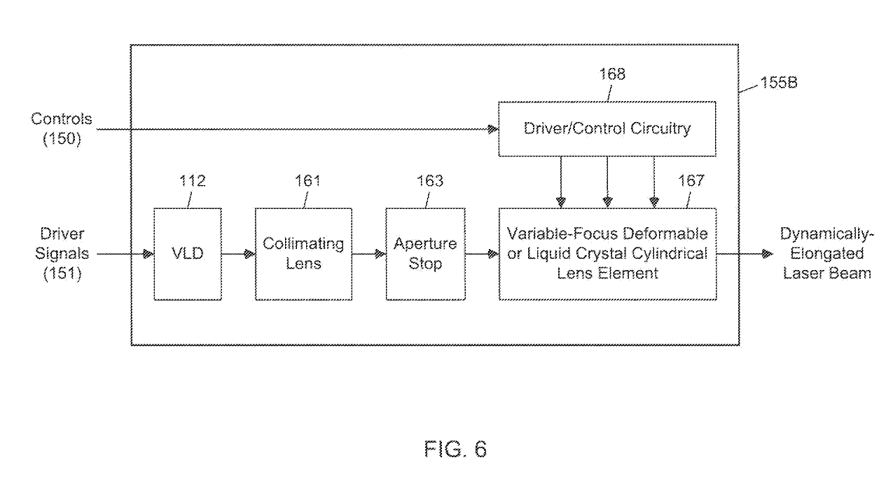

FIG. 5E shows an alternative embodiment of a fully assembled dynamically-elongated laser beam production module 155A′ based on the design shown in FIG. 4A, but using a reflective-type cylindrical (i.e. beam elongating) optical element in lieu of a refractive-type cylindrical lens, in the hand-supportable laser scanning bar code symbol reading system of FIG. 3. As shown, the optical module comprises: multi-cavity laser source 112 (e.g. multi-cavity VLD), installed in a yoke assembly 160, having a focusing/collimating lens (i.e. with 4.0 [mm] focal length) 161; a lens holder 162 for holding focusing lens 161, having an aperture stop 163 having a circular diameter of 0.94 [mm], along the common optical axis 165 of focusing lens 161, and multi-cavity VLD 112, as shown in FIG. 6; and a reflective-type beam elongating optical element (e.g. mirror) 163′ having a radius of curvature of about 95.54 [mm].

During operation, the adaptive variable-focus cylindrical lens element 166 is sequentially reconfigured during each laser scanning bar code symbol reading cycle, so that the electro-optical module 155A produces a laser beam having dynamically-changing beam elongation characteristics along the y axis (i.e. non-scanning) direction. This allows poor quality and degraded bar code symbols to be read by averaging out defects in the code symbols, while not be restricted by beam-code tilt requirements during scanning operations.

### Second Embodiment of the Dynamically-Elongated Laser Beam Production Module

FIG. 6 shows a dynamically-elongated laser beam production module based on the design illustrated in FIG. 4B, comprising: a visible laser diode 112; collimating lens 161 for collimating the laser beam from VLD 112; a variable-focus deformable or liquid crystal (LC) cylindrical lens element 167 for transforming the collimated laser beam into a dynamically-elongated laser beam; and a driver/control circuitry 168, interfacing electro-optical element 167 and system controller 150, for controlling the operation of the variable-focus deformable or liquid crystal (LC) cylindrical lens element 167.

During operation, the adaptive variable-focus cylindrical lens element 167 is sequentially reconfigured during each laser scanning bar code symbol reading cycle, so that the electro-optical module 155B produces a laser beam having dynamically-changing beam elongation characteristics along the y axis (i.e. non-scanning) direction. This allows poor quality and degraded bar code symbols to be read by averaging out defects in the code symbols, while not be restricted by beam-code tilt requirements during scanning operations.

The object of laser beam production modules 155B is essentially the same as module 155A, namely: to produce a laser beam 113 (114B) having an Elongation Ratio (ER) which dynamically changes between extreme values during each laser scanning cycle (e.g. trigger event) so as to increase the performance of the laser scanning bar code symbol reading system attempting to read different types of degraded bar code symbols, under different operating conditions.

FIG. 7 describes an optical model for the laser scanning beam production module employed in the hand-supportable laser scanning bar code symbol reading system of FIG. 3, illustrating, at an instant in time, the 1/e² scan and cross scan dimensions of the beam profile of a dynamically-elongated laser scanning beam being projected onto and scanned across a degraded bar code symbol.

FIGS. 7B and 7C show the X and Y dimension characteristics of the dynamically-elongated laser scanning beam 114B, respectively, taken at the x-waist location along the direction of propagation (i.e. z axis) and produced when laser cavity no. 1 is activated in the laser scanning bar code symbol reading system of FIG. 3.

FIGS. 7D and 7E show the X and Y dimension characteristics of the dynamically-elongated laser scanning beam 114B, respectively, taken at the x-waist location along the direction of propagation (i.e. z axis) and produced when laser cavity nos. 1 and 2 are activated in the laser scanning bar code symbol reading system of FIG. 3.

FIGS. 7F and 7G show the X and Y dimension characteristics of the dynamically-elongated laser scanning beam 114B, respectively, taken at the x-waist location along the direction of propagation (i.e. z axis) and produced when laser cavity nos. 1, 2 and 3 are activated in the laser scanning bar code symbol reading system of FIG. 3.

FIGS. 7H and 7I show the X and Y dimension characteristics of the dynamically-elongated laser scanning beam 114B, respectively, taken at the x-waist location along the direction of propagation (i.e. z axis) and produced when laser cavity nos. 1, 2, 3 and 4 are activated in the laser scanning bar code symbol reading system of FIG. 3.

As summarized in FIG. 7J, the 1/e² beam diameter along the height (Y) dimension of the laser beam remains substantially constant for different distances along the Z axis, regardless of the number of laser cavities activated during system operation.

As summarized in FIGS. 7K1 and 7K2, the 1/e² beam diameter along the height (Y) dimension of the laser beam increases with the number of laser cavities activated, and as a function of distance along the Z axis. Specifically, the 1/e² beam diameter along the height (X) dimension of the laser beam, as a function of Z, is minimum when only a single laser cavity is activated, and maximum when all four laser cavities are activated.

As summarized in FIGS. 7L and 7M, the elongation ratio (Y/X) of the laser beam increases as a function of distance along beam travel (Z) direction, for increasing number of laser cavities activated in the laser scanning bar code symbol reading system of FIG. 3. Thus, when scanning an object at a particular location along the Z axis, the elongation ratio (ER) of the laser scanning beam produced from bar code symbol reading system of FIG. 3 will dynamically change, many times, between the four different discrete ER values indicated in FIGS. 7L and 7M, during each laser scanning cycle initiated upon each triggering event. The speed at which the ER of the laser beam varies over time is so fast that the change in height (Y) dimension of the laser beam is undetectable to the unaided human eye during laser scanning operations, so that the highest (Y) dimension value of the laser beam is what is detected and smaller beam height values are typically undetectable during scanning operations, but nevertheless still existent to help read bar code symbols at extreme tilt angles, with improved performance.

### Specification of Modes of Operation of the Laser Scanning Bar Code Reader

In general, system 100 supports a manually-triggered triggered mode of operation, and also an automatically-triggered mode of operation, described below.

In response to a triggering event (i.e. manually pulling trigger 104), the laser scanning module 105 generates and projects a dynamically-elongated laser scanning beam 114B through the light transmission window 103, and across the laser scanning field 115 external to the hand-supportable housing, for scanning an object in the scanning field. The laser scanning beam is generated by the laser beam source 112 and optics 161, 163 and 164, in response control signals generated by the system controller 150. The scanning element (i.e. mechanism) 134 repeatedly scans the selected laser beam across a code symbol residing on an object in the near portion or far portion of the laser scanning field 115. Each time the laser scanning beam starts its scanning operation, and ends its scanning operation across the laser scanning field 115, the start of scan/end of scan detector 136 automatically generates start of scan (SOS) and an end of scan (EOS) timing signal, which is supplied to the system controller 150 for time and control purposes. During laser beam scanning operations, the light collection optics 106 collects light reflected/scattered from scanned code symbols on the object in the scanning field, and the photo-detector (106) automatically detects the intensity of collected light (i.e. photonic energy) and generates an analog scan data signal corresponding to the light intensity detected during scanning operations. The analog scan data signal processor/digitizer 107 processes the analog scan data signals and converts the processed analog scan data signals into digitized data signals. The programmed decode processor 108 decode processes digitized data signals, and generates symbol character data representative of each bar code symbol scanned by a dynamically-elongated laser scanning beam 114B. Symbol character data corresponding to the bar codes read by the decoder 108, are then transmitted to the host system via the I/O communication interface 140 which may support either a wired and/or wireless communication link, well known in the art. During object detection and laser scanning operations, the system controller 150 generates the necessary control signals for controlling operations within the hand-supportable laser scanning bar code symbol reading system 100.

In response to the automatic detection of an object in the laser scanning field 115, by IR-based object presence detection subsystem 225, the laser scanning module 105 generates and projects a dynamically-elongated laser scanning beam 114B through the light transmission window 103, and across the laser scanning field 115 external to the hand-supportable housing, for scanning an object in the scanning field. The laser scanning beam 114B is generated by laser source 112 in response control signals generated by the system controller 150. The scanning element (i.e. mechanism) 134 repeatedly scans the laser beam 114B across the scanning field 115 containing a bar code symbol 116. Each time the laser scanning beam starts its scanning operation, and ends its scanning operation across the laser scanning field 115, the start of scan/end of scan detector 136 automatically generates start of scan (SOS) and an end of scan (EOS) timing signal, which is supplied to the system controller 150 for time and control purposes. During laser beam scanning operations, the light collection optics 106 collects light reflected/scattered from scanned code symbols on the object in the scanning field, and the photo-detector (106) automatically detects the intensity of collected light (i.e. photonic energy) and generates an analog scan data signal corresponding to the light intensity detected during scanning operations. The analog scan data signal processor/digitizer 107 processes the analog scan data signals and converts the processed analog scan data signals into digitized data signals. The programmed decode processor 108 decode processes digitized data signals, and generates symbol character data representative of each bar code symbol scanned by dynamically-elongated laser scanning beam 114B. Symbol character data corresponding to the bar codes read by the decoder 108, are then transmitted to the host system via the I/O communication interface 140 which may support either a wired and/or wireless communication link, well known in the art. During object detection and laser scanning operations, the system controller 150 generates the necessary control signals for controlling operations within the hand-supportable laser scanning bar code symbol reading system 100.

### Method of Reading Bar Code Symbols and Controlling Operations Within the Laser Scanning Bar Code Reader

Referring to FIG. 8, the method of reading bar code symbols and controlling operations within the laser scanning bar code reader 100, will be described in greater detail below.

As indicated in FIG. 8, the process orchestrated by system controller 150 begins at the START Block, where all system components are activated. As indicated at Block A1 in FIG. 8, the system controller 150 continues to determine when an object has been detected anywhere in the field of view (FOV), and when this event occurs, the system controller determines at Block A2 whether or not the IR-based object detection subsystem 225 detects an object in the near portion of the scanning field 115. In the event an object has been detected in the near portion of the scanning field, then at Block B, the system controller directs the laser scanning module 105 to scan the detected object with a dynamically-elongated laser beam 114B generated by module 155A or 155B, described above.

At Block C, the decode processor 108 runs a decode algorithm on the captured scan data, and if at Block D, a bar code symbol is decoded, then at Block E, the produced symbol character data is transmitted to the host system, and the system controller returns to Block A1. If, however, at Block D a bar code symbol is not decoded, then the system controller 150 determines at Block F1 whether or not the maximum scan attempt threshold has been reached, and if not, then the system controller 150 returns to Block B, and resumes the flow as indicated. However, if at Block F1, the system controller 150 determines that the maximum scan attempt threshold has been accomplished, then optionally, the system controller 150 proceeds to Block F2 and sends a Failure to Decode notification to the operator and returns to Block A1.

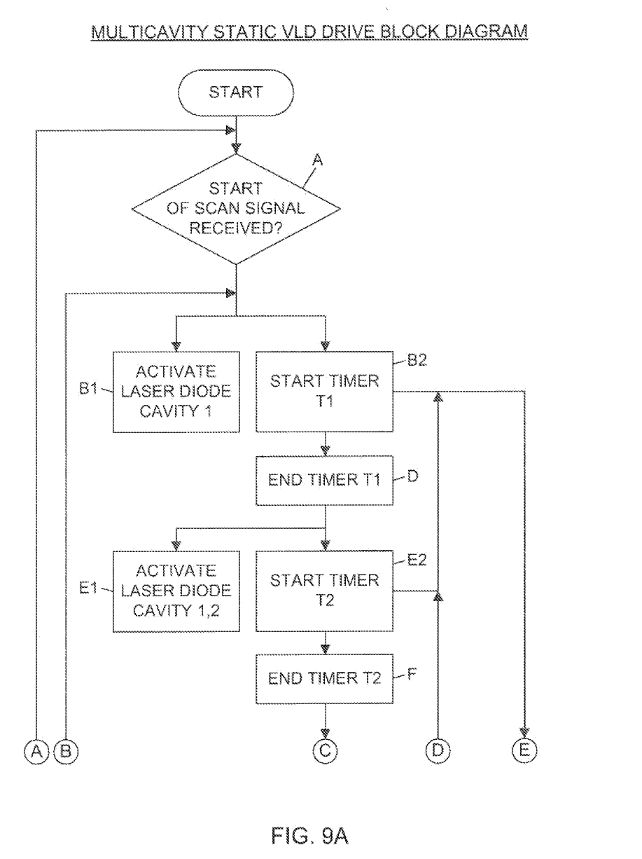

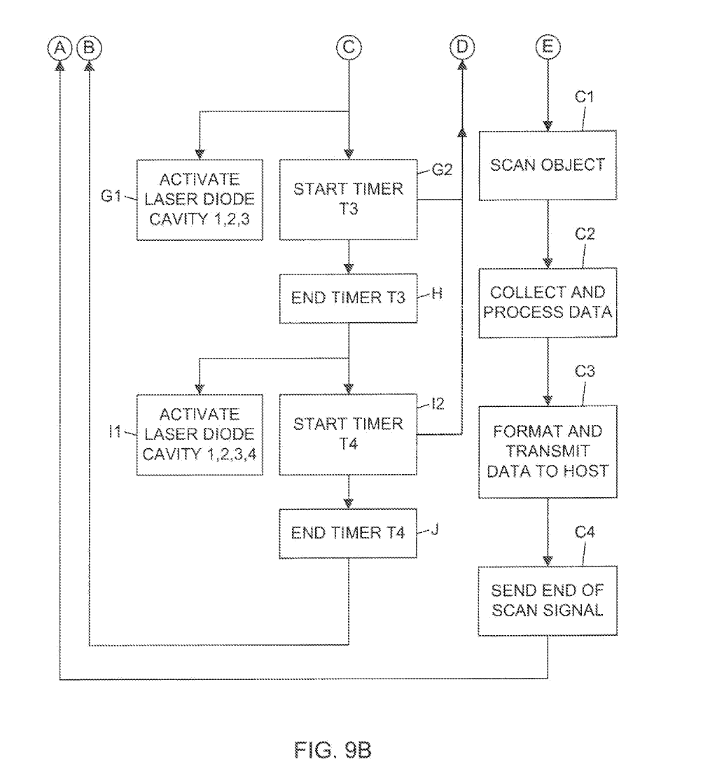

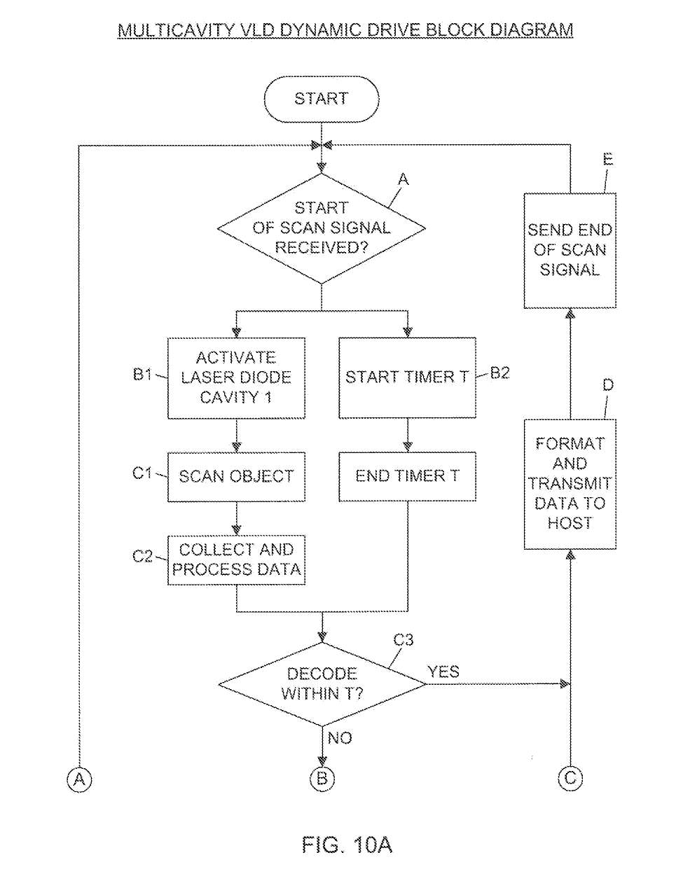

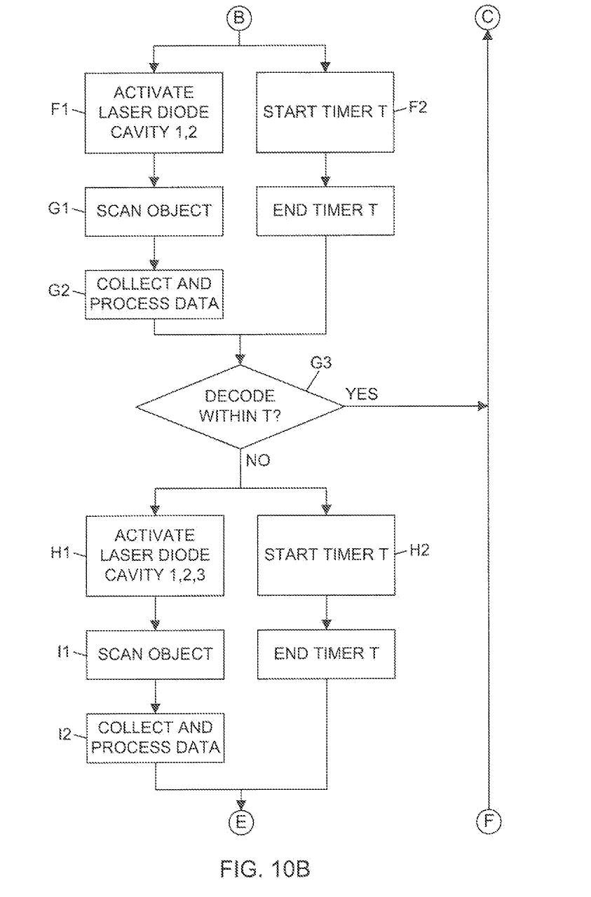

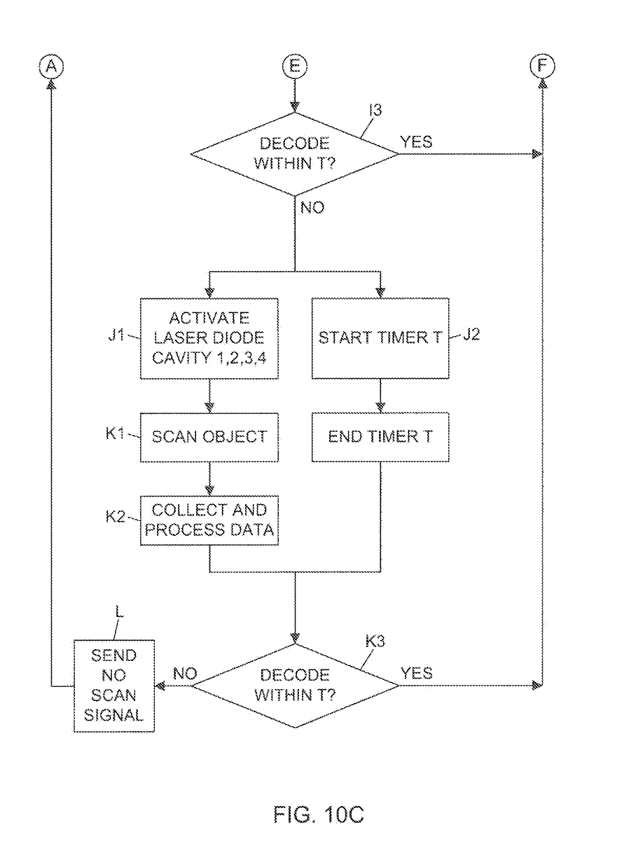

If at Block A2, an object is not detected in the near portion of the laser scanning field 115, then at Block G in FIG. 8, the system controller directs the laser scanning module 105 to scan the detected object with a dynamically-elongated laser beam generated by module 155A or 155B, driven according to either the static or dynamic multi-cavity VLD control process described in FIGS. 9 and 10, respectively.

At Block H, one or more decode algorithms are run on the collected scan data, and at Block I, the system controller 150 determines whether or not a bar code symbol is decoded by decode processor 108.

If at Block I, a bar code symbol is decoded, then at Block J the produced symbol character data produced is transmitted to the host system, and system control returns to Block A1, as shown in FIG. 8. If, however, at Block I, no bar code symbol is decoded, then the system controller 150 determines whether or not the maximum scan attempt threshold (i.e. how many attempts to decode are permitted) has been reached, and so long as the maximum number has not been reach, the system controller 150 maintains a control loop between Blocks K and G, as indicated in FIG. 8. When the maximum number of attempts to decode has been reached at Block K, then optionally, system controller 150 sends a Failure to Decode notification to the operator, and the system returns to Block A1, as shown in FIG. 8.

### Static-Type Process for Driving the Dynanically-Elongated Laser Beam Production Module Employed in the Laser Scanning Bar Code Symbol Reading System

FIG. 9 describes a first exemplary control process for driving the electo-optical modules 155A and 155B employed in the hand-supportable laser scanning bar code symbol reading system of FIG. 3, during each trigger event indicated in FIG. 8. For purposes of illustration, the control process of FIG. 9 will be described below with reference to the multi-cavity based electro-optical module 155B. However, it is understood, that the control process of FIG. 9 can be used to control the operation of the adaptable/deformable lens based electro-optical module 155A, wherein activating discrete elongation ratio (ER) states of electro-optical module 155A corresponds to activating particular laser cavities (and corresponding ER states) in electro-optical module 155B.

During this multi-cavity VLD control process, a single laser beam sweep occurs each 0.01 [Seconds] and that the beam elongation, the ER state, and the SNR of the dynamically-generated laser beam changes every laser beam sweep (i.e. every 0.01 seconds). At the same time the Y-dimension of the laser beam switches among its four discrete states, each sweep interval, the X-dimension (beam width) of the laser beam is maintained substantially constant over time. Each time the laser scanning beam starts its scanning operation, and ends its scanning operation across the laser scanning field 115, the start of scan/end of scan detector 136 automatically generates start of scan (SOS) and an end of scan (EOS) timing signal, which is supplied to the system controller 150 for time and control purposes. Such timing control signals are used by the system controller 150 to determine when to activate the multi-cavity VLD with different control signals, and change the state of its laser output beam during laser scanning bar code symbol reading operation.

As indicated at Block A in FIG. 9, the first step involves determining whether or not the system controller received a start of scan (SOS) signal from the detector 136, and if so then activates laser diode cavity no. 1 at Block B1 and starts timer T1 at Block B2. While timer T1 is running, the system controller orchestrates the scanning of the object in the scanning field at Block C1, collecting and processing scan data from the object at Block C2, formatting and transmitting symbol character data to the host computer system at Block C3 if a successful decode event occurs at Block C2, and then generating and sending an end of scanning (EOS) signal, at Block C4, indicating a return to Block A, as shown.

When timer T1 times out, as indicated at Block D, the system controller activates laser diode cavities nos. 1 and 2 at Block E1 and starts timer T2 at Block E2. While timer T2 is running, the system controller orchestrates the scanning of the object in the scanning field at Block C1, collecting and processing scan data from the object at Block C2, formatting and transmitting symbol character data to the host computer system at Block C3 if a successful decode event occurs at Block C2, and then generating and sending an end of scanning (EOS) signal, at Block C4, indicating a return to Block A, as shown.

When timer T3 times out, as indicated at Block F, the system controller activates laser diode cavities nos. 1, 2 and 3 at Block G1 and starts timer T3 at Block G2. While timer T3 is running, the system controller orchestrates the scanning of the object in the scanning field at Block C1, collecting and processing scan data from the object at Block C2, formatting and transmitting symbol character data to the host computer system at Block C3 if a successful decode event occurs at Block C2, and then generating and sending an end of scanning (EOS) signal, at Block C4, indicating a return to Block A, as shown.

When timer T3 times out, as indicated at Block H, the system controller activates laser diode cavities nos. 1, 2, 3 and 4 at Block I1 and starts timer T4 at Block I2. While timer T4 is running, the system controller orchestrates the scanning of the object in the scanning field at Block C1, collecting and processing scan data from the object at Block C2, formatting and transmitting symbol character data to the host computer system at Block C3 if a successful decode event occurs at Block C2, and then generating and sending an end of scanning (EOS) signal, at Block C4, indicating a return to Block A, as shown.

When timer T4 times out, as indicated at Block J, the system controller automatically returns to Blocks B1 and B2 as shown, to resume the automated activation of the multi-cavity VLD, as specified at Blocks B1 through I1, until eventually a bar code symbol on an object is successfully scanned and decoded, and its symbol character data transmitted to the host system, as indicated at Block C3, when the end of scan (EOS) signal is generated at Block C4, and laser scanning operations are terminated until a SOS signal is received at Block A.

### Dynamic-Type Process for Driving the Dynamically-Elongated Laser Beam Production Module Employed in the Laser Scanning Bar Code Symbol Reading System

FIG. 10 describes a second exemplary control process for driving electro-optical modules 155A or 155B employed in the hand-supportable laser scanning bar code symbol reading system of FIG. 3, during each trigger event indicated in FIG. 8. For purposes of illustration, the control process in FIG. 10 is described with reference to the multi-cavity based electro-optical module 155B. However, it is understood, that the control process of FIG. 10 can be used to control the operation of the adaptable/deformable lens based electro-optical module 155A, wherein activating discrete elongation ratio (ER) states of electro-optical module 155A corresponds to activating particular laser cavities (and corresponding ER states) in electro-optical module 155B.

During the multi-cavity VLD control process of FIG. 10, a single laser beam sweep also occurs each 0.01 [Seconds] and that the beam elongation, the ER state, and the SNR of the dynamically-generated laser beam changes every laser beam sweep (i.e. every 0.01 seconds). At the same time the Y-dimension of the laser beam switches among its four discrete states, each sweep interval, the X-dimension (beam width) of the laser beam is maintained substantially constant over time. Each time the laser scanning beam starts its scanning operation, and ends its scanning operation across the laser scanning field 115, the start of scan/end of scan detector 136 automatically generates start of scan (SOS) and an end of scan (EOS) timing signal, which is supplied to the system controller 150 for time and control purposes. Such timing control signals are used by the system controller 150 to determine when to activate the electro-optical modules 155A and 155B with different control signals, and change the state of its laser output beam during laser scanning bar code symbol reading operation.

### Performance Characteristics of the Dynamically-Elongated Laser Scanning Beam Produced from the Laser Scanning Device of FIG. 3 to Scan Various Types Of 1D And 2D Stacked Bar Code Symbols

The structure and operation of the laser scanning bar code symbol reading system 100 of the illustrative embodiment has been described above.

FIG. 11 shows the laser beam elongation ratio (ER) vs. time characteristics at the x beam waist location of laser beam produced from a four-cavity VLD, after beam collimating optics, without the use of beam elongation optics. Notably, in response to each trigger event, the laser beam is swept across the scanning field at a rate of a single (1) laser beam sweep each 0.01 [Seconds]. As shown in FIG. 11, without beam elongation optics, the discrete ER increments are 1.0, 1.25, 1.5 and 1.75. As shown, the ER changes each and every laser beam sweep across the scan field (occurring within 0.01 seconds). Also, the X-dimension (beam width) is maintained constant over time, while the Y-dimension varies over time in multiples of sweep time.

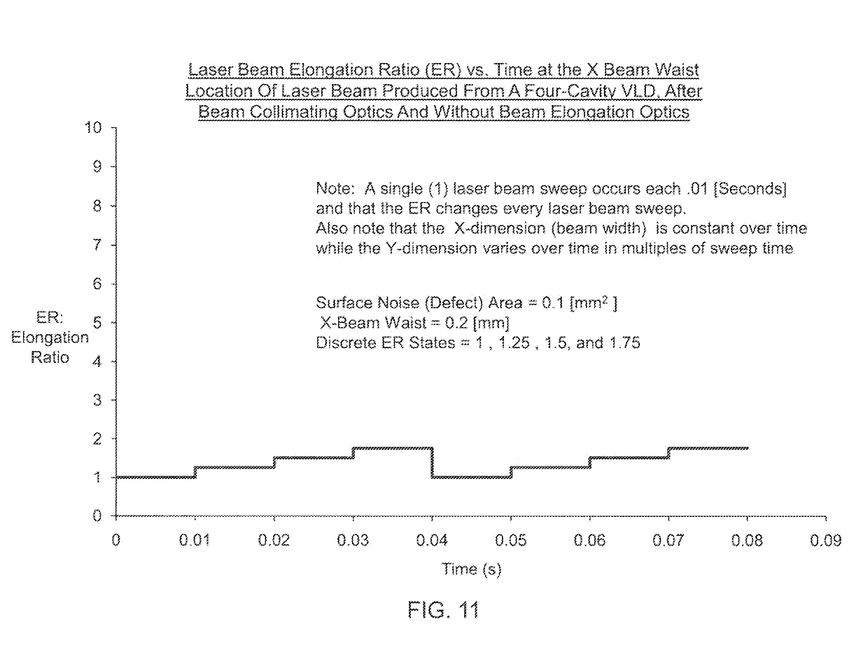

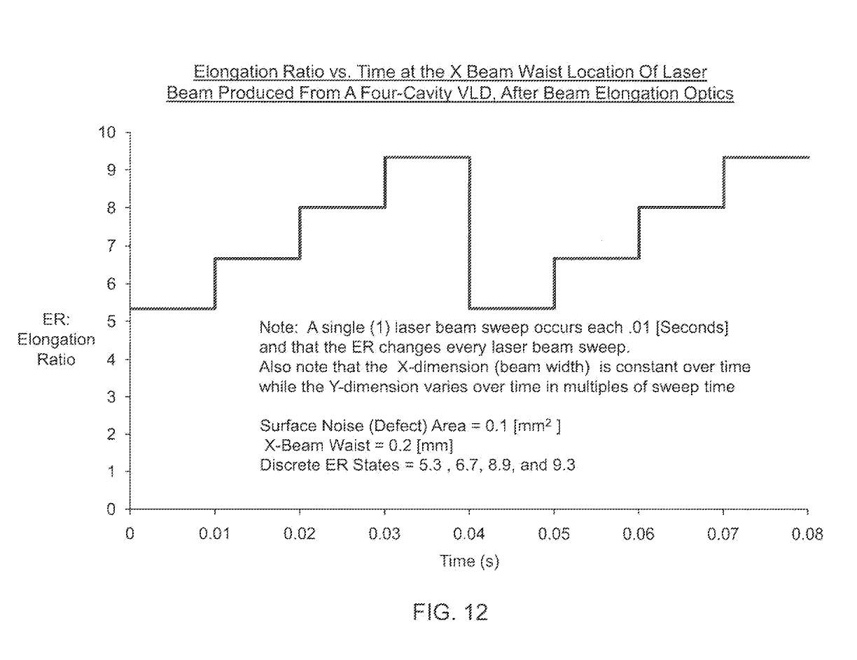

FIG. 12 shows the laser beam elongation ratio (ER) vs. time characteristics, at the x beam waist location of laser beam produced from a four-cavity VLD in the hand-supportable laser scanning bar code symbol reading system of FIG. 3, after beam elongation optics. During this scanning process, the x (width) dimension of the laser beam remains essentially constant over time, while the y (height) dimension of the laser beam varies, in discrete increments, during each scanning interval (i.e. 0.01 seconds). As shown in FIG. 12, with beam elongation optics, the discrete ER increments are 5.3, 6.7, 8.9 and 9.3.

### Measuring the Signal to Noise Ratio (SNR) of Dynamically-Elongated Laser Beams, Produced from a Laser Scanning Bar Code Symbol Reader when Different Elongation Ratio States are Activated

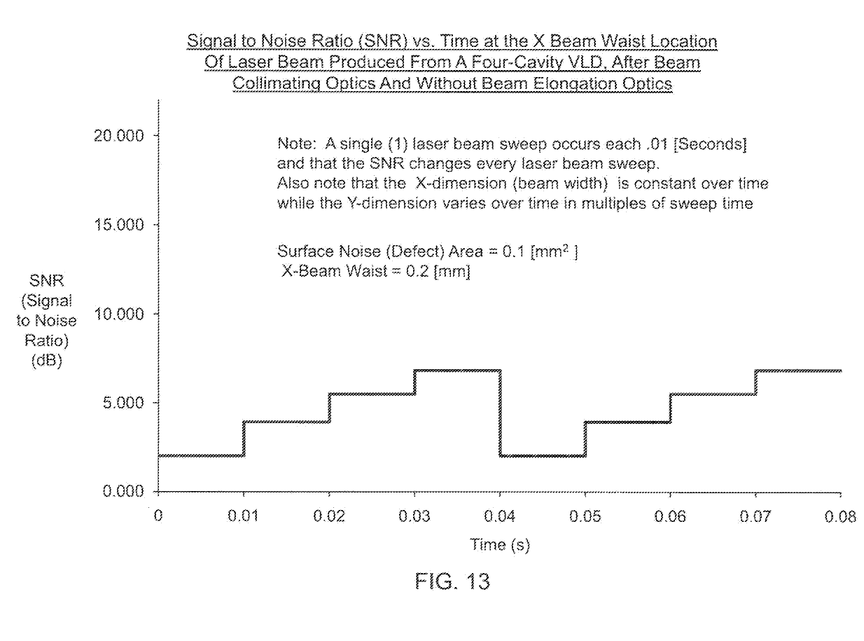

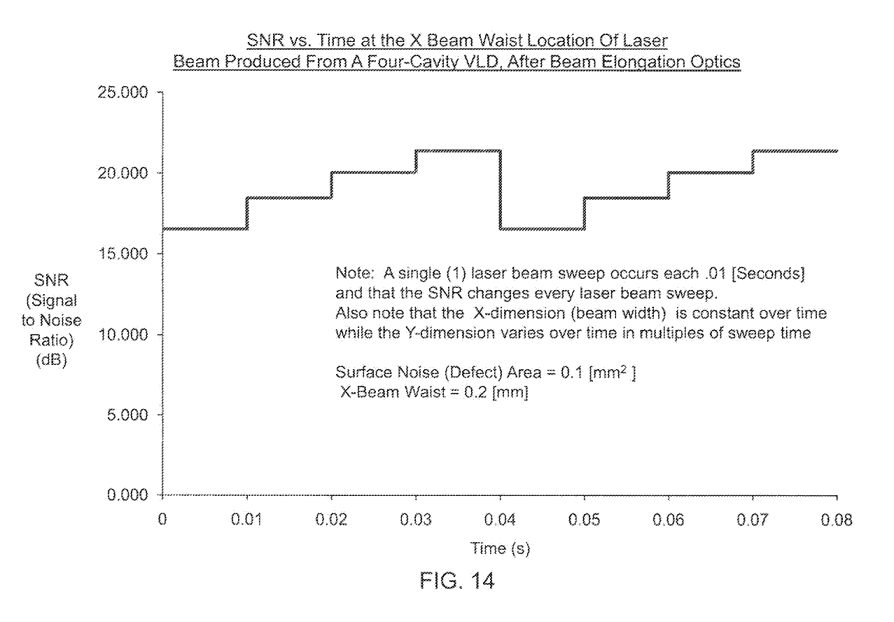

In FIGS. 13 and 14, the novel signal to noise (SNR) characteristics of dynamically-changing laser scanning beam 114B are shown, during each scanning cycle, for the cases where beam elongation optics have not been employed, and where beam elongation optics have been employed, respectively. As shown, the SNR changes each and every laser beam sweep across the scan field (occurring within 0.01 seconds).

During this scanning process, the x (width) dimension of the laser beam remains essentially constant over time, while the y (height) dimension of the laser beam varies, in discrete increments, during each scanning interval (i.e. 0.01 seconds). As shown in FIG. 13, without beam elongation optics, the discrete SNR increments are 2.3, 4.75, 5.5, and 7.5. As shown in FIG. 14, with beam elongation optics, the discrete SNR increments are 17.0, 19.0, 2.5, and 22.5

### Performance of the Dynamically-Elongated Laser Scanning Beam when Scanning Various Types of 1D And 2D Stacked Bar Code Symbologies

It is appropriate at this juncture to describe the performance of the dynamically-elongated laser scanning beam 114B, when it is used to laser-scan various types of 1D and 2D stacked bar code symbologies.

### Scanning Perfect UPC Bar Code Symbols Using a Dynamically-Elongated (DE) Laser Scanning Beam Produced from the Hand-Supportable Laser Scanning Bar Code Symbol Reader

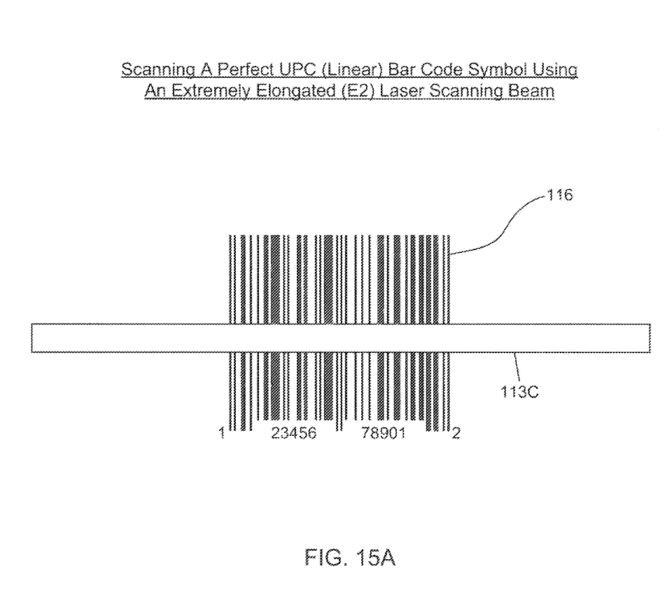

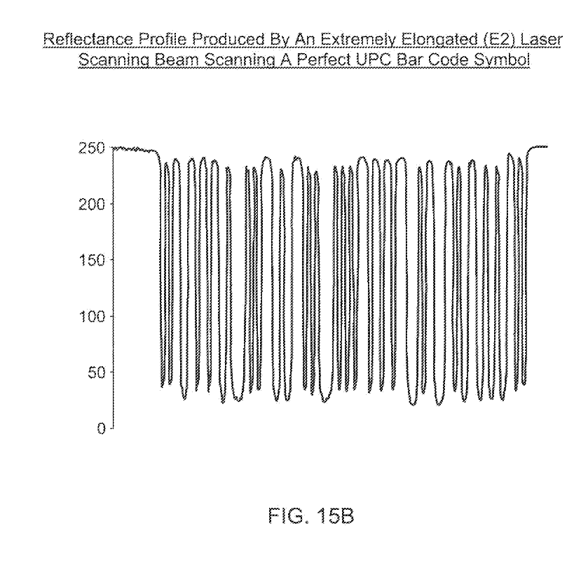

FIG. 15A illustrates a perfect UPC bar code symbol being scanned by a dynamically-elongated (DE) laser scanning beam produced from the hand-supportable laser scanning bar code symbol reading system of FIG. 3. FIG. 15B shows the reflectance profile produced by the dynamically-elongated (DE) laser scanning beam projected from the laser scanning bar code symbol reading system while scanning the perfect UPC bar code symbol shown in FIG. 15A. While not apparent from the illustration in FIG. 15A, during each triggered laser scanning process, the height-wise (Y), or non-scan, dimension of the laser beam 114B, dynamically changes between its four discrete elongation ratio (ER) and corresponding SNR states, such that laser scanning beam having different ER state is generated for each laser scanning sweep, under the control of the multi-cavity VLD control process illustrated in FIG. 9 or 10.

### Scanning Degraded UPC Bar Code Symbols Using a Dynamically-Elongated (DE) Laser Scanning Beam Produced from the Hand-Supportable Laser Scanning Bar Code Symbol Reader

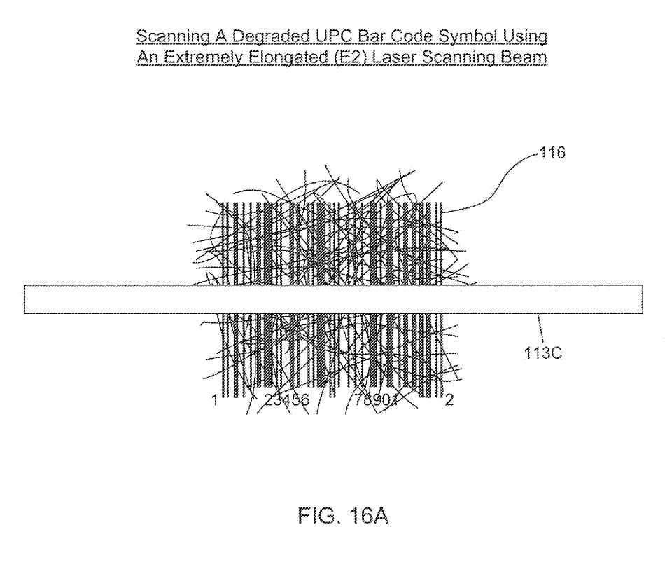

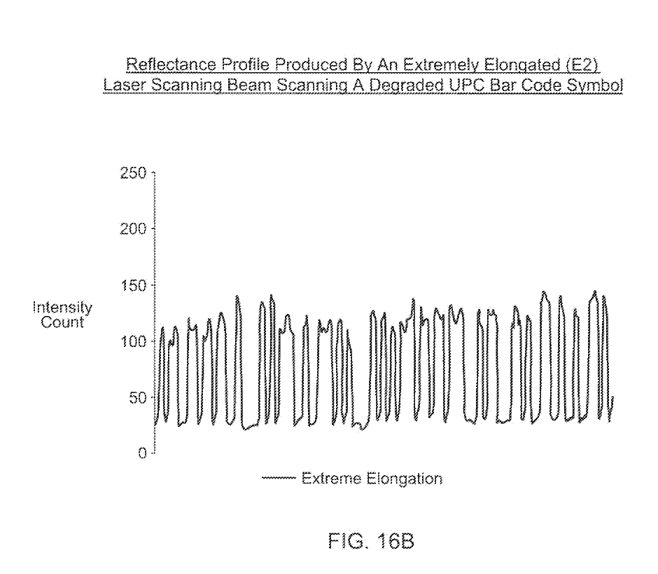

FIG. 16A illustrates a degraded UPC bar code symbol being scanned by a dynamically-elongated (DE) laser scanning beam produced from the hand-supportable laser scanning bar code symbol reading system of FIG. 3. FIG. 16B shows the reflectance profile produced by the dynamically-elongated (DE) laser scanning beam projected from the laser scanning bar code symbol reading system while scanning the degraded UPC bar code symbol shown in FIG. 16A. While not apparent from the illustration in FIG. 16A, during each triggered laser scanning process, the height-wise (Y), or non-scan, dimension of the laser beam 114B, dynamically changes between its four discrete elongation ratio (ER) and corresponding SNR states, such that laser scanning beam having different ER state is generated for each laser scanning sweep, under the control of the multi-cavity VLD control process illustrated in FIG. 9 or 10.

### Scanning Stacked 2D Bar Code Symbols Using a Dynamically-Elongated (DE) Laser Scanning Beam Produced from the Hand-Supportable Laser Scanning Bar Code Symbol Reader

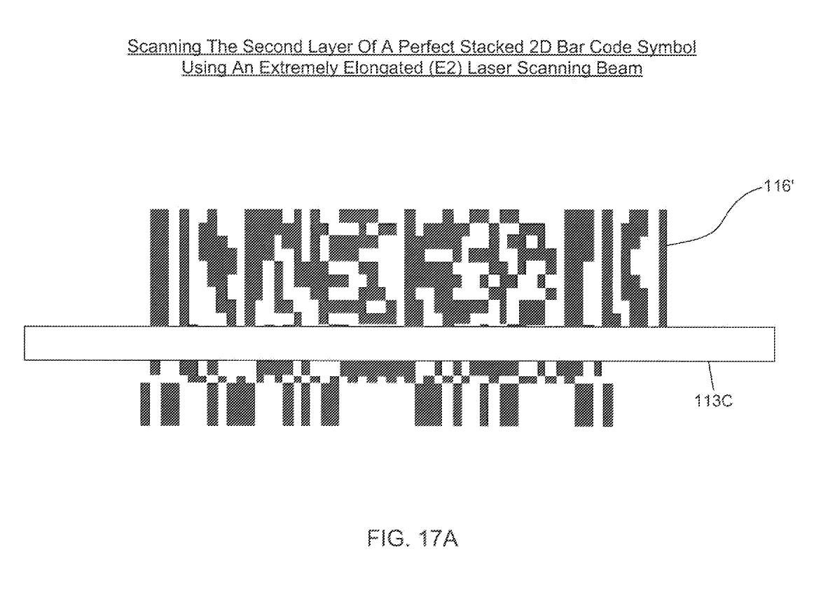

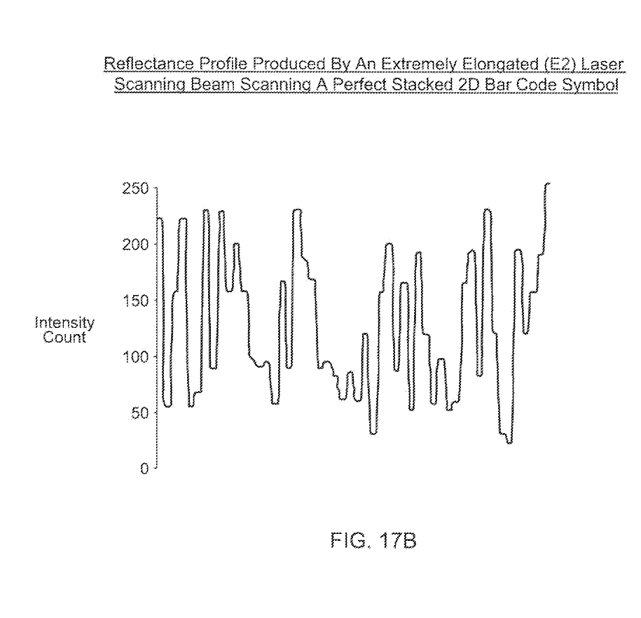

FIG. 17A illustrates the second layer of a stacked 2D bar code symbol being scanned by a dynamically-elongated (DE) laser scanning beam produced from the hand-supportable laser scanning bar code symbol reading system of FIG. 3. In this case, the height (y) dimension of the dynamically-elongated laser beam on the scanning plane is greater than the height dimension of the bar elements in the second layer of the 2D stacked bar code symbol. FIG. 17B shows the reflectance profile produced by the dynamically-elongated (DE) laser scanning beam projected from the laser scanning bar code symbol reading system while scanning the second layer of the stacked 2D bar code symbol shown in FIG. 17A. While not apparent from the illustration in FIG. 17A, during each triggered laser scanning process, the height-wise (Y), or non-scan, dimension of the laser beam 114B, dynamically changes between its four discrete elongation ratio (ER) and corresponding SNR states, such that laser scanning beam having different ER state is generated for each laser scanning sweep, under the control of the processes illustrated in FIG. 9 or 10.

### Advantages Gained by Using Dynamically-Elongated Laser Scanning Beam During Laser Scanning Bar Code Symbol Reading Operations

A primary advantages gained by using a dynamically-elongated laser scanning beam during laser-scanning based bar code symbol reading operations, as disclosed herein, is that there is (i) a significant improvement in SNR performance when reading degraded bar code symbols of various types, but (ii) without a significant decrease in performance when laser scanning bar code symbols at significant beam-symbol tilt angles.

### Some Modifications Which Readily Come to Mind

While the illustrative embodiments disclosed the use of a 1D laser scanning beams to detect bar code symbols on objects, it is understood that a 2D or raster-type laser scanning beam (patterns), using dynamically-elongated laser beams, can be used as well, to scan 1D bar code symbols, 2D stacked linear bar code symbols, and 2D matrix code symbols, and generate scan data signals for decoding processing.

Also, the illustrative embodiment have been described in connection with various types of code symbol reading applications involving 1-D and 2-D bar code structures (e.g. 1D bar code symbols, 2D stacked linear bar code symbols, and 2D matrix code symbols). Hereinafter, the term “code symbol” shall be deemed to include all such code symbols.

It is understood that the digital-imaging based bar code symbol reading system of the illustrative embodiments may be modified in a variety of ways which will become readily apparent to those skilled in the art of having the benefit of the novel teachings disclosed herein. All such modifications and variations of the illustrative embodiments thereof shall be deemed to be within the scope of the Claims appended hereto.

What is claimed is:

1. A laser scanning bar code symbol reading system for scanning and reading poor quality or damaged bar code symbols, said laser scanning bar code symbol reading system having a working range and comprising:
a housing having a light transmission window;
a dynamically-elongated laser beam production module for producing, in response to a triggering event, a dynamically-elongated laser beam having (i) a direction of propagation extending along a z reference direction, (ii) a height dimension being indicated by the y reference direction, and (iii) a width dimension being indicated by the x reference direction, where x, y and z directions are orthogonal to each other;
wherein said dynamically-elongated laser beam is characterized by an elongation ratio (ER) that is defined as Y/X where, for any point within said working range of said laser scanning bar code symbol reading system, extending along said z direction,
(i) Y indicates the beam height of said dynamically-elongated laser beam measured in said Y reference direction,
(ii) X indicates the beam width of said dynamically-elongated laser beam measured in the X reference direction, and
(iii) said beam height (Y) and said laser beam width (X) are measured at 1/e² intensity clip level; and
(iv) the elongation ratio of said dynamically-elongated laser beam changes among a set of discrete ER values during each laser scanning bar code symbol reading cycle initiated by said triggering event; and
a laser scanning mechanism for scanning said dynamically-elongated laser beam out said light transmission window and across a scanning field defined external to said housing, in which a bar code symbol is present for scanning by said dynamically-elongated laser scanning beam.

2. The laser scanning bar code symbol reading system of claim 1, wherein said elongation ratio (ER) varies of the range of greater than 1.5 up to over 9.2 over the working range of said laser scanning bar code symbol reading system, along said z reference direction.

3. The laser scanning bar code symbol reading system of claim 1, wherein said bar code symbol is a code symbol selected from the group consisting of 1D bar code symbols, and 2D stacked bar code symbols.

4. The laser scanning bar code symbol reading system of claim 1, wherein said elongation ratio has a peak value of greater than 4.5 occurring at the waist of said dynamically-elongated laser scanning beam.

5. The laser scanning bar code symbol reading system of claim 1, wherein said dynamically-elongated laser beam production module comprises a laser drive circuit for generating and delivering laser drive current signals to a multi-cavity laser source having multiple laser cavities, and wherein one or more of said laser cavities can be activated and driven during the laser scanning bar code reading cycle, to produce said dynamically-elongated laser scanning beam.

6. The laser scanning bar code symbol reading system of claim 5, which further comprises:
light collection optics for collecting light reflected/scattered from scanned object in the scanning field, and a photo-detector for detecting the intensity of collected light and generating an analog scan data signal corresponding to said detected light intensity during scanning operations;
an analog scan data signal processor/digitizer for processing the analog scan data signals and converting the processed analog scan data signals into digital scan data signals, which are then converted into digital words representative of the relative width of the bars and spaces in the scanned code symbol structure;
programmed decode processor for decode processing digitized data signals, and generating symbol character data representative of each bar code symbol scanned by said dynamically-elongated laser scanning beam.

7. The laser scanning bar code symbol reading system of claim 6, which further
an input/output (I/O) communication interface module for interfacing with a host communication system and transmitting symbol character data thereto via wired or wireless communication links that are supported by the symbol reading system and host system; and
a system controller for generating the necessary control signals for controlling operations within said laser scanning bar code symbol reading system.

8. The laser scanning bar code symbol reading system of claim 6, wherein said housing comprises a hand-supportable housing.

9. The laser scanning bar code symbol reading system of claim 6, wherein said multi-cavity laser source comprises a multi-cavity visible laser diode (VLD) having multiple laser cavities.

10. The laser scanning bar code symbol reading system of claim 6, wherein said triggering event is generated by manually pulling a trigger switch associated with said housing or by an automatic object detector detecting an object in said laser scanning field.

11. A laser scanning system for scanning poor quality or damaged bar code symbols, said laser scanning system having a working range and comprising:
a housing having a light transmission window;
a dynamically-elongated laser beam production module for producing, in response to a triggering event, a dynamically-elongated laser beam having (i) a direction of propagation extending along a z reference direction, (ii) a height dimension being indicated by the y reference direction, and (iii) a width dimension being indicated by the x reference direction, where x, y and z directions are orthogonal to each other;
wherein said dynamically-elongated laser beam is characterized by an elongation ratio (ER) that is defined as Y/X, where for any point within said working range of said laser scanning bar code symbol reading system, extending along said z direction,
(i) Y indicates the beam height of said dynamically-elongated laser beam measured in said Y reference direction,
(ii) X indicates the beam width of said dynamically-elongated laser beam measured in the X reference direction, and
(iii) said beam height (Y) and said laser beam width (X) are measured at 1/e² intensity clip level; and
(iv) the elongation ratio of said dynamically-elongated laser beam changes among a set of discrete ER values during each laser scanning bar code symbol reading cycle initiated by said triggering event; and
a laser scanning mechanism for scanning said dynamically-elongated laser beam out said light transmission window and across a scanning field defined external to said housing, in which a bar code symbol is present for scanning by said dynamically-elongated laser scanning beam.

12. The laser scanning system of claim 11, wherein said elongation ratio varies of the range of greater than 1.5 up to over 9.2 over the working range of said laser scanning system, along said z reference direction.

13. The laser scanning system of claim 11, wherein said bar code symbol is a code symbol selected from the group consisting of 1D bar code symbols, and 2D stacked bar code symbols.

14. The laser scanning system of claim 11, wherein said elongation ratio has a peak value of greater than 4.5 occurring at the waist of said dynamically-elongated laser scanning beam.

15. The laser scanning system of claim 11, wherein said dynamically-elongated laser beam production module comprises a laser drive circuit for generating and delivering laser (diode) drive current signals to a multi-cavity laser source having multiple laser cavities, wherein one or more of said laser cavities can be activated and driven during the laser scanning bar code reading cycle, to produce said dynamically-elongated laser scanning beam.

16. The laser scanning system of claim 15, wherein said multi-cavity laser source comprises a multi-cavity visible laser diode (VLD) having multiple laser cavities.

17. The laser scanning bar code symbol reading system of claim 11, wherein said triggering event is generated by manually pulling a trigger switch associated with said housing or by an automatic object detector detecting an object in said laser scanning field.

18. The laser scanning system of claim 11, which further comprises:
light collection optics for collecting light reflected/scattered from scanned object in the scanning field, and a photo-detector for detecting the intensity of collected light and generating an analog scan data signal corresponding to said detected light intensity during scanning operations;
an analog scan data signal processor/digitizer for processing the analog scan data signals and converting the processed analog scan data signals into digital scan data signals, which are then converted into digital words representative of the relative width of the bars and spaces in the scanned bar code symbol;
programmed decode processor for decode processing digitized data signals, and generating symbol character data representative of each bar code symbol scanned by said dynamically-elongated laser scanning beam.

19. The laser scanning system of claim 11, which further comprises: an adaptive variable focus optical component to create the dynamically-elongated laser beam production module in the Y reference dimension.

20. The laser scanning system of claim 11, wherein said housing comprises a hand-supportable housing.

21. A method of scanning a laser scanning a bar code symbol comprising the steps:
(a) in response to a triggering event, producing from a hand-supportable housing, a dynamically-elongated laser beam having (i) a direction of propagation extending along a z reference direction, (ii) a height dimension being indicated by the y reference direction, and (iii) a width dimension being indicated by the x reference direction, where x, y and z directions are orthogonal to each other;
wherein said dynamically-elongated laser beam is characterized by an elongation ratio (ER) that is defined as Y/X, where, for any point within said working range of said laser scanning bar code symbol reading system, extending along said z direction;
(i) Y indicates the beam height of said dynamically-elongated laser beam measured in said Y reference direction,
(ii) X indicates the beam width of said dynamically-elongated laser beam measured in the X reference direction,
(iii) said beam height (Y) and said laser beam width (X) are measured at 1/e² intensity clip level, and
(iv) the elongation ratio of said dynamically-elongated laser beam changes among a set of discrete ER values during each laser scanning bar code symbol reading cycle initiated by said triggering event; and
(b), scanning said dynamically-elongated laser beam across a scanning field defined external to said hand-supportable housing, in which a bar code symbol is present for scanning by said dynamically-elongated laser scanning beam.

22. The method of claim 20, which further comprises:
(c) collecting light reflected/scattered from scanned bar code symbol in said scanning field, and detecting the intensity of said collected light and generating an analog scan data signal corresponding to said detected light intensity during scanning operations;
(d) processing said analog scan data signals and converting the processed analog scan data signals into digital scan data signals, and then converted said digital scan data signals into digital words representative of the relative width of the bars and spaces in the scanned bar code symbol; and
(e) decode processing digitized scan data signals, and generating symbol character data representative of each bar code symbol scanned by said dynamically-elongated laser scanning beam.

23. The method of claim 20, wherein said elongation ratio varies of the range of greater than 1.5 up to over 9.2 over the working range of said laser scanning bar code symbol reading system, along said z reference direction.

24. The method of claim 20, wherein said bar code symbol is a code symbol selected from the group consisting of 1D bar code symbols, and 2D stacked bar code symbols.

25. The method of claim 20, wherein said elongation ratio has a peak value of greater than 4.5 occurring at the waist of said dynamically-elongated laser scanning beam.

26. The method of claim 20, wherein step (a) comprises generating said triggering event by manually pulling a trigger switch associated with said housing or by an automatic object detector detecting an object in said laser scanning field.
